(19) United States
(12) Patent Application Publication
(10) Pub. No.: US 2012/0005378 A1
(43) Pub. Date: Jan. 5, 2012

(54) INFORMATION PROCESSING APPARATUS, CONTROL METHOD, AND PROGRAM

(75) Inventors: Koichi Abe, Yokohama-shi (JP); Daisuke Ishizuka, Kawasaki-shi (JP)

(73) Assignee: CANNON KABUSHIKI KAISHA, Tokyo (JP)

(21) Appl. No.: 13/163,101

(22) Filed: Jun. 17, 2011

(30) Foreign Application Priority Data
Jun. 30, 2010 (JP) 2010-150266
Jul. 13, 2010 (JP) 2010-159169

(51) Int. Cl. G06F 13/10

(52) U.S. Cl. 710/18

(57) ABSTRACT

A peripheral device control system with high operability, which can provide a device management screen that provides appropriate display contents and functions according to a user's use environment, is implemented. The system is configured by an information processing apparatus, a peripheral device, a peripheral device management function required to manage the peripheral device, a peripheral device management screen, peripheral device management function control information, a first application, a first driver, and a second driver. When the first application is launched from the peripheral device management screen, a first driver name is generated using a second driver name, and is set as a default device.

### BACKGROUND OF THE INVENTION

1. Field of the Invention

The present invention relates to an information processing apparatus upon using a peripheral device, a control method thereof, and a program. The present invention relates to a peripheral device control method applied to an information processing apparatus, and a program for controlling a computer to execute the peripheral device control method.

2. Description of the Related Art

Windows® 7 available from Microsoft is introduced with new functions of managing peripheral devices connected to an information processing apparatus such as a personal computer (hereinafter referred to as a PC). These functions include a [Devices and Printers] folder as a window which displays devices connected to a PC, and “Device Stage®” which has a link function to applications and services unique to respective peripheral devices. The [Devices and Printers] folder screen (FIG. 5A) can be displayed from a “start menu” of Windows. From the [Devices and Printers] folder screen, a Device Stage screen (FIG. 5B) of respective peripheral devices can be opened. Device Stage can provide a visual screen, and allows the user to easily access device-related functions and services. Examples of peripheral devices include a printer, copying machine, facsimile apparatus, scanner, digital camera, digital video camera, multifunction printer including a storage, and multifunction peripheral including these functions. In this case, a scanner will be exemplified as a peripheral device. For example, a link to an application which allows the user to scan an image or document may be provided from the Device Stage screen. In case of this example, the application that allows the user to scan an image or document is launched from the Device Stage screen, and the user can scan an image or document using the peripheral device (scanner).

Along with the popularization of the Internet, increasingly information processing apparatuses and peripheral devices are connected to the Internet, and various online services using the Internet are provided. For example, when a link to a support site provided by a manufacturer on the Internet is arranged on the Device Stage screen, the user can easily access the device-related site. Device Stage includes metadata configured only in an XML format file and resource files such as images and icons. When this metadata, that is XML, image, and icon files, are customized for each peripheral device, display contents and functions of Device Stage for that peripheral device can be customized. Operation control is described in the XML file. Since the XML file is a text file, it cannot have any arbitrary functions and variables incorporated in software such as a general program. However, an OS provides variables that can be used in the XML file of Device Stage for some pieces of information supported by the OS. The variables include that for a printer driver name (friendly name) assigned to a printer queue, and that for a WIA driver name assigned to a WIA driver for a scanner function using WIA (to be described later). However, a variable for a TWAIN driver name assigned to a TWAIN driver for a scanner function using TWAIN (to be described later) is not provided from the OS. In the following description of this embodiment, the Device Stage screen may also be referred to as a device management screen.

Conventionally, an image or document is generally scanned from an application using a scanner function of an MFP in the following operation procedures.

(1-1) The application is launched.

(1-2) A scanner (driver) as an input device is selected from a scanner selection field in the application.

(1-3) A scanning operation is executed from the application.

For example, when a plurality of input devices such as an MFP and scanner are connected to a single PC, and drivers of these input devices are installed in the PC, once the scanning operation is executed, the input device which was selected last is normally selected as a default device when this application is launched for the next time (for example, see Japanese Patent Laid-Open No. 2005-85132).

When an application linked from Device Stage is launched to scan an image or document set on an MFP, a series of procedures are different from the conventional procedures. More specifically, when the Device Stage screen is displayed via the [Devices and Printers] folder screen, the following operation procedures are made.

(2-1) The [Devices and Printers] folder is opened.

(2-2) A peripheral device to be operated is selected from the [Devices and Printers] folder.

(2-3) A Device Stage screen for that peripheral device is opened.

(2-4) The application is launched from the Device Stage screen.

(2-5) A scanning operation is executed from the application.

For example, a case will be examined below wherein when a plurality of input devices such as an MFP and scanner are connected to a single PC, and drivers of these input devices are installed, a scanning operation has been done once using a certain scanner from a certain application. At this time, when this application is launched for the next time, this scanner is selected as a default device. In this case, an attempt is made to execute a scanning operation of an image or document set on an MFP different from that default scanner from the application using the MFP in the operations of steps (2-1) to (2-5) above. In step (2-5), when the scanning operation is executed from the application, this application executes the scanning operation of an image or document from the scanner set as a default device in this application in place of the MFP. As a result, an expected image or document cannot be scanned, and the image or document scanning operation fails.

Next, a case will be examined below wherein an MFP is connected to a single PC via a plurality of interfaces such as USB and an Ethernet® network. In such case, a driver name for the MFP changes depending on interfaces to be connected. For example, as will be described later using FIG. 6B, in case of a USB-connection TWAIN driver, a driver name “ABC Kmmn (TWAIN)” is displayed on a scanner selection field in the application. Also, in case of a WSD protocol network-connection TWAIN driver, a driver name “ABC Kmmn (TWAIN)_************” is displayed on the scanner selection field in the application. In this case, a serial number of the MFP is assigned to the part “************”. In general, this serial number is normally configured using a MAC address (Media Access Control Address) uniquely given to hardware of a communication unit of that MFP. Now assume that the MFP is connected to a single PC via two interfaces of USB and an Ethernet network. Based on the conventional operation procedures, a USB-connection TWAIN driver “ABC Kmmn (TWAIN)” is selected from the scanner selection field in the application in step (1-2), and a scanning operation is executed using the MFP via USB from the application in step (1-3). At the completion timing of the scanning operation, when this application is launched the next time, this USB-connection TWAIN driver “ABC Kmmn (TWAIN)” is selected as the default device. Next, a USB cable is disconnected from the MFP to set a state in which the MFP is connected to the PC via only the Ethernet network. From this state, an attempt is made to launch the application linked from Device Stage and to execute a scanning operation by the MFP via the Ethernet network using a WSD protocol network-connection TWAIN driver “ABC Kmmn (TWAIN)_AABBCCXX0814”. In step (2-5), when the scanning operation is executed from the application, this application attempts to execute the scanning operation of an image or document using the USB-connection TWAIN driver “ABC Kmmn (TWAIN)” in place of the WSD protocol network-connection TWAIN driver “ABC Kmmn (TWAIN)_AABBCCXX0814”. As a result, since the MFP is not connected to the PC via USB, an expected image or document cannot be scanned, and the image or document scanning operation fails.

Furthermore, a case will be examined below wherein two MFPs which have the same model name but different serial numbers are connected on a single network, and TWAIN drivers for these MFPs are installed in a single PC. At this time, assume that TWAIN driver names assigned to these MFPs are respectively “ABC Kmmn (TWAIN)_AABBCCXX0814” and “ABC Kmmn (TWAIN)_AABBCCXX0707”. The model names of these MFPs are “Kmmn” and the serial numbers are respectively “AABBCCXX0814” and “AABBCCXX0707”.

For example, there is a case in which in software such as an application which can run on a PC, the application (software) sends an inquiry to a peripheral device to acquire a device ID and to acquire a model name and serial number of that peripheral device, which are included in the device ID, and executes subsequent control by substituting the model name and serial number in respective variables. In this case, the model name and serial number of the peripheral device need not be hard-coded, and the application can easily identify, for example, the same model or different individuals of the same model using the model name and serial number stored in the variables. Also, it is easy for the application to send an inquiry to the OS to acquire a TWAIN driver name assigned to each peripheral device, to substitute the acquired TWAIN driver name in a variable, and to specify and control the peripheral device to be operated using this variable.

By contrast, since the XML file in the metadata of Device Stage cannot use such variables, Device Stage has no choice but to depend on hard-coding that describes constants in the XML file. However, it is impossible to hard-code in advance an infinite number of pieces of information such as serial numbers required to identify individuals of peripheral devices in this XML file. For this reason, for example, when the serial numbers are appended to TWAIN driver names and are used to identify different individuals of the same model name on a network, it is difficult to launch a TWAIN-compatible application from Device Stage using the XML file and to identify and control each individual.

For example, a case will be examined below wherein two MFPs which have the same model name but different serial numbers are connected on a network, as described above. An MFP, as one of these MFPs, which is available from an ABC company, and has a model name “Kmmn” and a serial number “AABBCCXX0814” (to be referred to as “MFP 3” hereinafter) is connected to a PC via two interfaces of a USB and a network. An MFP, as the other MFP, which is available from the ABC company, and has a model name “Kmmn” and a serial number “AABBCCXX0707” (to be referred to as “MFP 777” hereinafter) is connected to the PC via only the network interface (FIG. 1).

Now assume that an application is launched to select a USB-connection TWAIN driver name “ABC Kmmn (TWAIN)” for the MFP 3, and is quitted after a scanning operation is made once. At this time, in the application, “ABC Kmmn (TWAIN)” is selected as a default device upon launching this application for the next time. In this case, when the application is launched to execute a scanning operation from a Device Stage screen for the MFP 777 by operations in steps (2-1) to (2-5) above, the application is launched from the Device Stage screen while designating, as a first argument, “ABC Kmmn (TWAIN) WSD” that indicates a network-connection TWAIN driver name for the model name “Kmmn” available from the ABC company. At this time, the application searches this first argument for the network-connection MFP having the model name “Kmmn” available from the ABC company. However, since this first argument does not include any information used to specify a serial number, the application cannot distinguish the MFPs 3 and 777 from each other. For this reason, the application is launched while setting the TWAIN driver name of either one MFP (which is found earlier at the time of a search) as a default device at the launch timing. As a result, the application is often launched while the TWAIN driver name “ABC Kmmn (TWAIN)_AABBCCXX0814” for the MFP 3 is selected, although the application is launched from the Device Stage screen for the MFP 777. In this case, the user cannot execute a scanning operation from the MFP 777, resulting in poor operability.

To summarize the above description, upon execution of an application associated with a device (especially, a TWAIN device) from Device Stage, the following problems are posed.

As a first program, upon execution of the application, when a specific device is stored in that application as a default device, that default device is unwantedly used irrespective of a device selected on Device Stage.

As a second problem, when a default device of the launched application is not connected, a device having a device name similar to a default device is unwantedly used irrespective of a device selected on Device Stage.

### SUMMARY OF THE INVENTION

The present invention has been made in consideration of the above problems, and provides a method which has high operability, provides a device management screen that provides appropriate display contents and functions according to a user's use environment, and can appropriately and reliably control a peripheral device in correspondence with the user's use environment when an application is launched to control the peripheral device.

More specifically, the present invention provides a method which controls an application to operate using a peripheral device associated upon launching when the application is launched via the aforementioned device management screen.

The present invention comprises the following arrangement.

That is, an information processing apparatus, which executes a peripheral device management program required to manage a peripheral device having unique information, and an application for the peripheral device, the apparatus comprises: an application launching unit, configured to instruct a function of the peripheral device management program to launch the application; a management unit, configured to manage peripheral device information including a device name of a peripheral device selected at a quit timing of the application, and unique information of the peripheral device; a setting unit, configured to set a device name as an argument when the application launching unit launches the application; and a control unit, configured to control the application to load peripheral device information that includes a device name matching the device name set as the argument and is managed by the management unit when the application launching unit launches the application, and controls to associate a peripheral device corresponding to unique information included in the loaded peripheral device information with the application.

According to another aspect, of the present invention an information processing apparatus, which executes a peripheral device management program required to manage a peripheral device having unique information, and a plurality of applications for the peripheral device, the apparatus comprises: an application launching unit, configured to instruct a function of the peripheral device management program to launch a first application and a second application; and a control unit, configured to acquire a driver name including unique information associated with the second application when the application launching unit launches the first application, and controls to associate a peripheral device corresponding to the unique information included in the acquired driver name with the first application.

According to still another aspect of the present invention, an information processing apparatus, which executes a peripheral device management program required to manage a peripheral device having unique information, and an application for the peripheral device, the apparatus comprises, as functions of the application: an acquisition unit as a first application function configured to acquire a device name as an argument when the application is instructed to be launched by a function of the peripheral device management program; a management unit as the application function configured to manage peripheral device information including a device name of a peripheral device selected at a quit timing of the application and unique information of the peripheral device; and a control unit as the application function configured to control to load peripheral device information that includes a device name matching the device name acquired as the argument and is managed by the management unit, and to associate a peripheral device corresponding to unique information included in the loaded peripheral device information with the application.

According to the present invention, the following effects can be obtained.

(1) When an application is launched in association with a device, that application operates using the device associated upon launching.

(2) A peripheral device control system which has high operability, and can provide a device management screen that provides appropriate display contents and functions according to a user's use environment can be implemented.

(3) Even when a plurality of peripheral devices which have the same model name but different serial numbers are connected on a single network, when an application (TWAIN application) is launched from a device management screen, since the peripheral device which was used when the application was launched previously is selected from those which have the same model name and are connected on the single network, the application (TWAIN) application can be launched while an appropriate peripheral device (TWAIN driver) is selected, resulting in high user's operability.

(4) An application (TWAIN application) automatically generates a TWAIN driver name dedicated to a peripheral device selected on a Device Stage (device management) screen using a variable that expresses a WIA driver name, and can be launched while the optimal TWAIN driver dedicated to that peripheral device is selected, resulting in high user's operability.

Further features of the present invention will become apparent from the following description of exemplary embodiments (with reference to the attached drawings).

### BRIEF DESCRIPTION OF THE DRAWINGS

FIG. 1 is a block diagram showing an arrangement part of a system according to an embodiment of a peripheral device control system including information processing apparatuses and peripheral devices according to the present invention;

FIGS. 2A and 2B are block diagrams showing examples of the hardware arrangements of a PC and MFP;

FIG. 3 is a view showing the software configuration of the PC;

FIG. 4 is a diagram showing the configuration of a printer driver in the PC;

FIGS. 5A and 5B are views showing a [Devices and Printers] folder and a device management screen;

FIGS. 6A, 6B, and 6C are views showing a WIA application and TWAIN application;

FIGS. 7A and 7B are views showing the software configurations of the PC;

FIG. 8 includes FIGS. 8A and 8B showing the contents of a device management control file 800;

FIG. 9 includes FIGS. 9A and 9B showing the contents of a device management control file 850;

FIG. 10 is a flowchart showing processing at the time of a device connection;

FIG. 11 is a flowchart showing installation processing of a device management control file;

FIG. 12 is a flowchart showing processing for launching a device management screen;

FIG. 13 is a flowchart showing processing for building the display contents of the device management screen;

FIG. 14 is a diagram showing the software configurations of a device management and TWAIN application;

FIG. 15 is a flowchart showing processing for launching the TWAIN application;

FIG. 16 is a flowchart showing processing for quitting the TWAIN application;

FIG. 17 includes FIGS. 17A and 17B as flowcharts showing processing for launching the TWAIN application;

FIG. 18 includes FIGS. 18A and 18B as flowcharts showing processing for launching the TWAIN application;

FIG. 19 is a view showing WSD-based N-PnP information issued from an MFP 888;

FIG. 20 is a view showing a scanner selector;

FIG. 21 includes FIGS. 21A and 21B as flowcharts showing processing for launching the TWAIN application; and

FIG. 22 is a flowchart showing processing of the scanner selector.

### DESCRIPTION OF THE EMBODIMENTS

Embodiments of the present invention will be described hereinafter with reference to the drawings. Of pieces of information of the Windows 7 operating system to be quoted in the following description, the pieces of information which are not appended with detailed descriptions are those published on the Internet at the Microsoft Developer Network (MSDN) site (http://msdn.microsoft.com/en-us/library/default.aspx) as of Apr. 20, 2010, and an excessive description thereof will be avoided.

In the following description, USB is a short for “Universal Serial Bus”, information of which is published at the Universal Serial Bus site (http://www.usb.org/home) as of Apr. 20, 2010. Hence, an excessive description thereof will be avoided.

In the following description, WSD is a short for “Web Services on Devices”, and is information published at the Windows Hardware Developer Central site (http://www.microsoft.com/whdc/connect/rally/rallywsd.m spx) as of Apr. 20, 2010. Hence, an excessive description thereof will be avoided.

In the following description, WIA is a short for “Windows Image Acquisition”, and is a standard interface (API) used to input an image from, for example, an image scanner on the Windows Operating System. Hence, an excessive description thereof will be avoided.

In the following description, TWAIN is an interface between a PC and a scanner or digital camera, which is managed by the TWAIN Working Group, and is information published at the TWAIN Working Group site (http://www.twain.org/) as of Apr. 20, 2010. Hence, an excessive description thereof will be avoided.

### First Embodiment

<Network Arrangement Example>

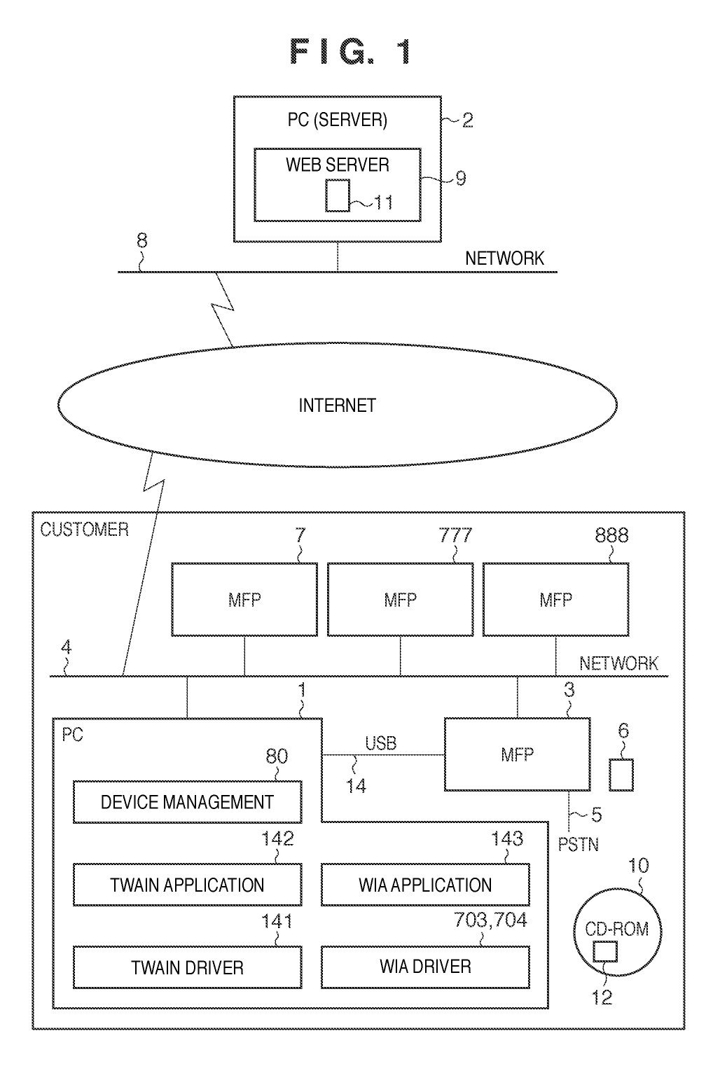

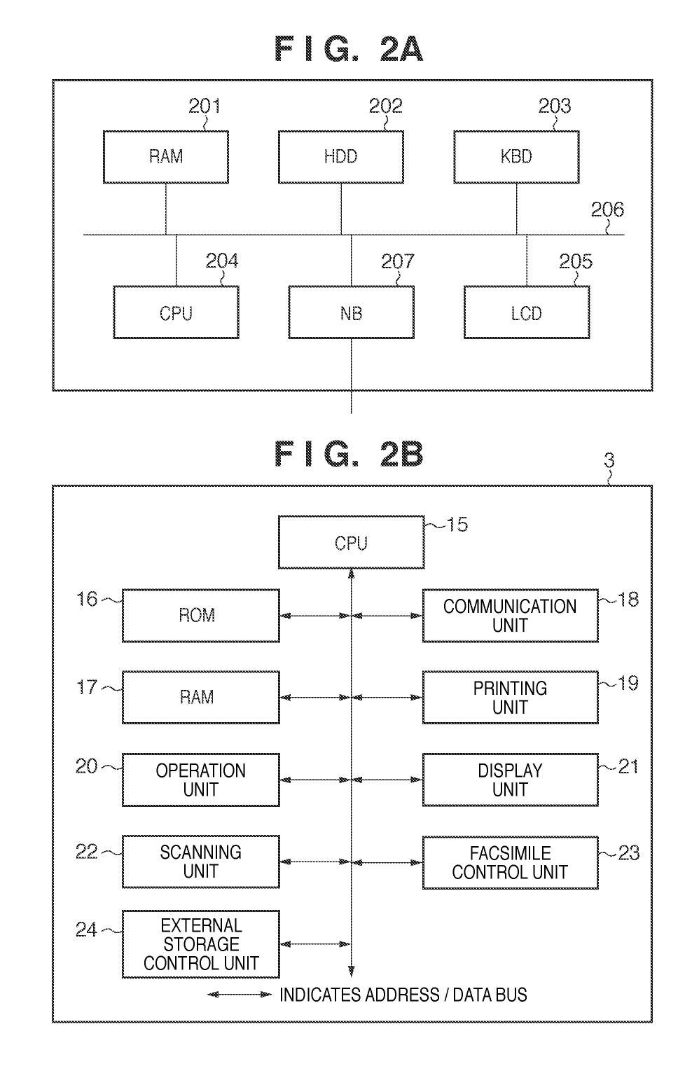

FIG. 1 is a block diagram showing an arrangement part of a system according to an embodiment of a peripheral device control system including information processing apparatuses and peripheral devices according to the present invention. Referring to FIG. 1, each of information processing apparatuses 1 and 2 is configured by a general personal computer (to be also abbreviated as a PC hereinafter). The PCs 1 and 2 have a hardware arrangement shown in FIG. 2A, and are installed with an operating system (to be also abbreviated as an OS hereinafter) equivalent to Windows 7 available from Microsoft, U.S.A. The PCs 1 and 2 are respectively connected to Ethernet® networks 4 and 8. For example, the PC 1 serves as a peripheral device control apparatus which controls peripheral devices such as MFPs. Each of the multi-function printers (to be abbreviated as MFPs hereinafter) 3, 777, and 888 is configured by, for example, a color ink-jet printer, color facsimile apparatus, color scanner, or external storage for a flash memory. These MFPs are examples of peripheral devices in this embodiment.

Both the MFPs 3 and 777 have a model name “Kmmn” available from an ABC company, and they respectively have serial numbers “AABBCCXX0814” and “AABBCCXX0707”. The serial numbers of these MFPs use MAC addresses of their network interfaces intact. The serial number is unique information unique to each peripheral device, that is, the MFP. The MFP 888 has a model name “Mnmk” available from the ABC company, and a serial number “YY1218YY0730”. The MFP 888 is compatible to two network interfaces for a wireless LAN (IEEE802.11b/g/n) and wired LAN (Ethernet). The MFP 888 has a mechanism for exclusively switching the wireless and wired LANs like that when the wireless LAN is valid, the wired LAN is invalid; when the wired LAN is valid, the wireless LAN is invalid. For this reason, the serial number does not use a MAC address intact, and assumes a value “YY1218YY0730” as a combination of lower 24 bits of a MAC address “AABBCCYY1218” as a wireless LAN device and those of a MAC address “AABBCCYY0730” as a wired LAN device. FIG. 1 illustrates a state in which the MFP 888 is connected to the PC 1 via the network 4 while the wired LAN (Ethernet) is valid. In this case, upper 24 bits “AABBCC” of the MAC address correspond to manufacturer information assigned to the ABC company as a manufacturer. Note that peripheral devices of this embodiment may also include a printer, copying machine, facsimile apparatus, scanner, digital camera, digital video camera, and multifunction peripheral including these functions.

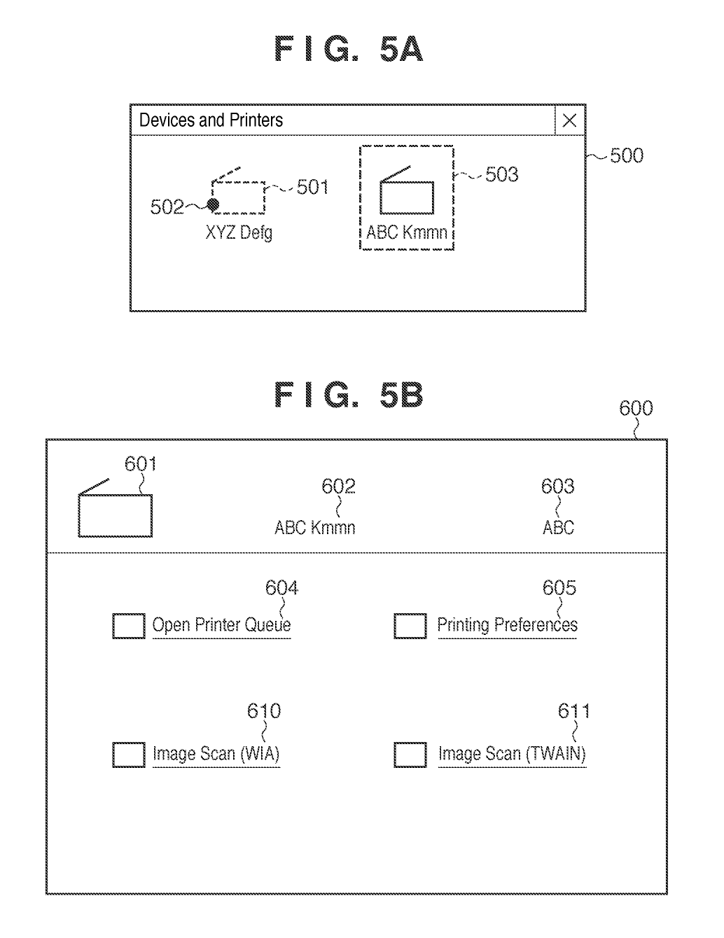

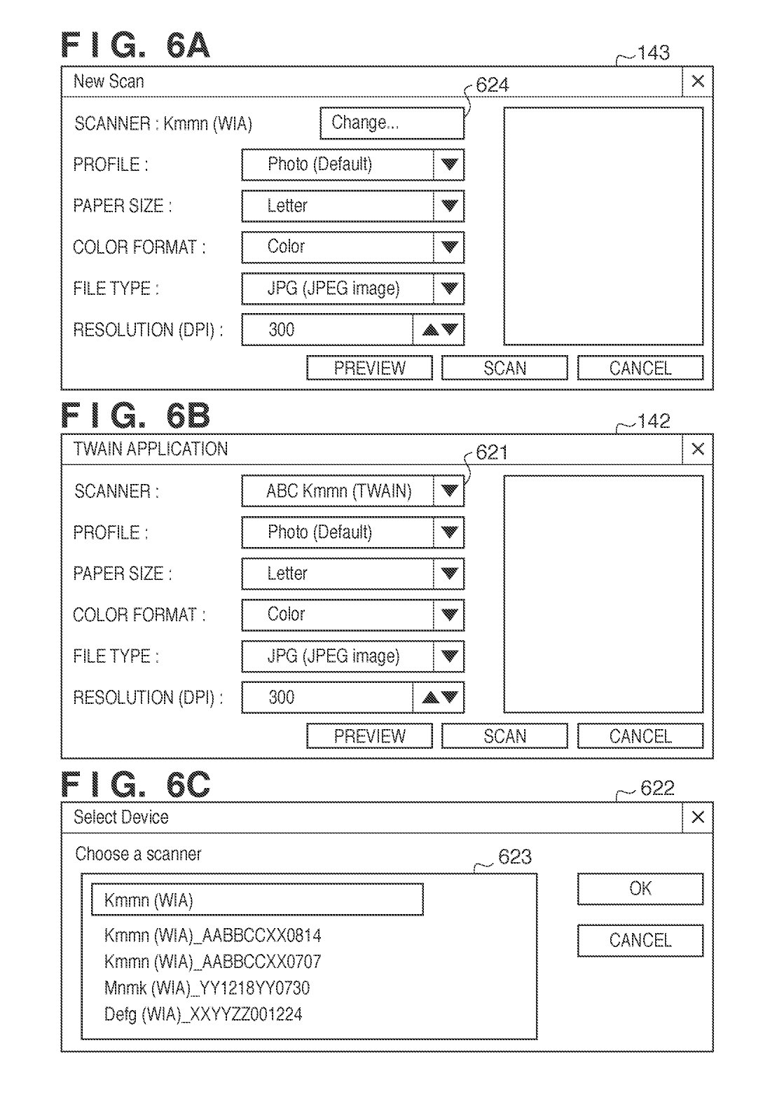

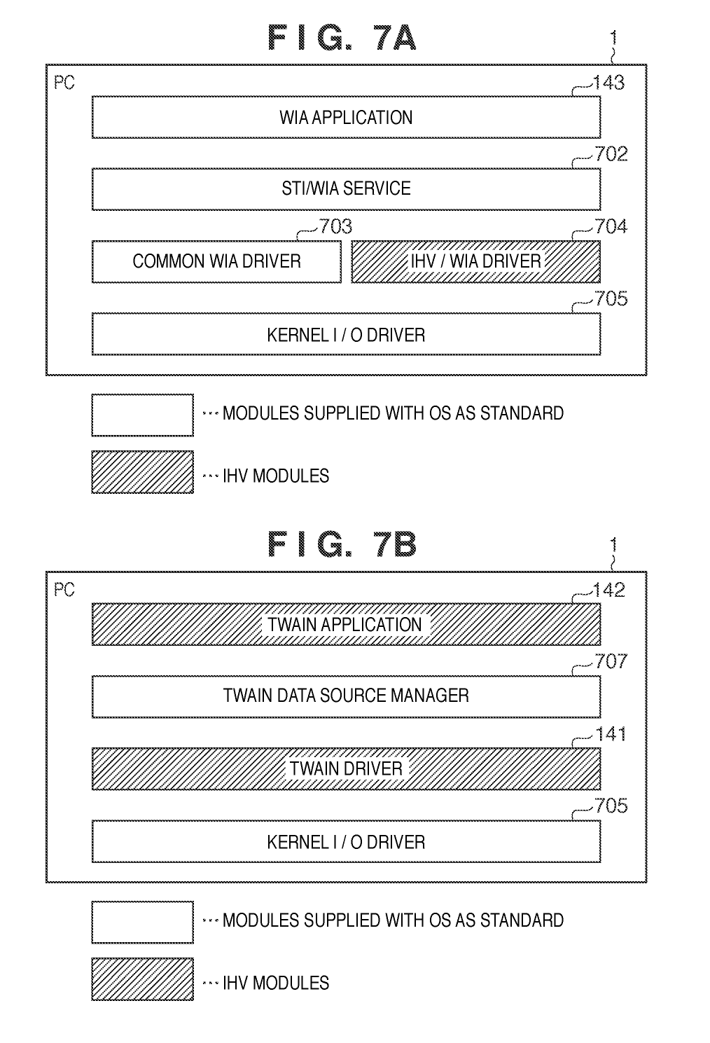

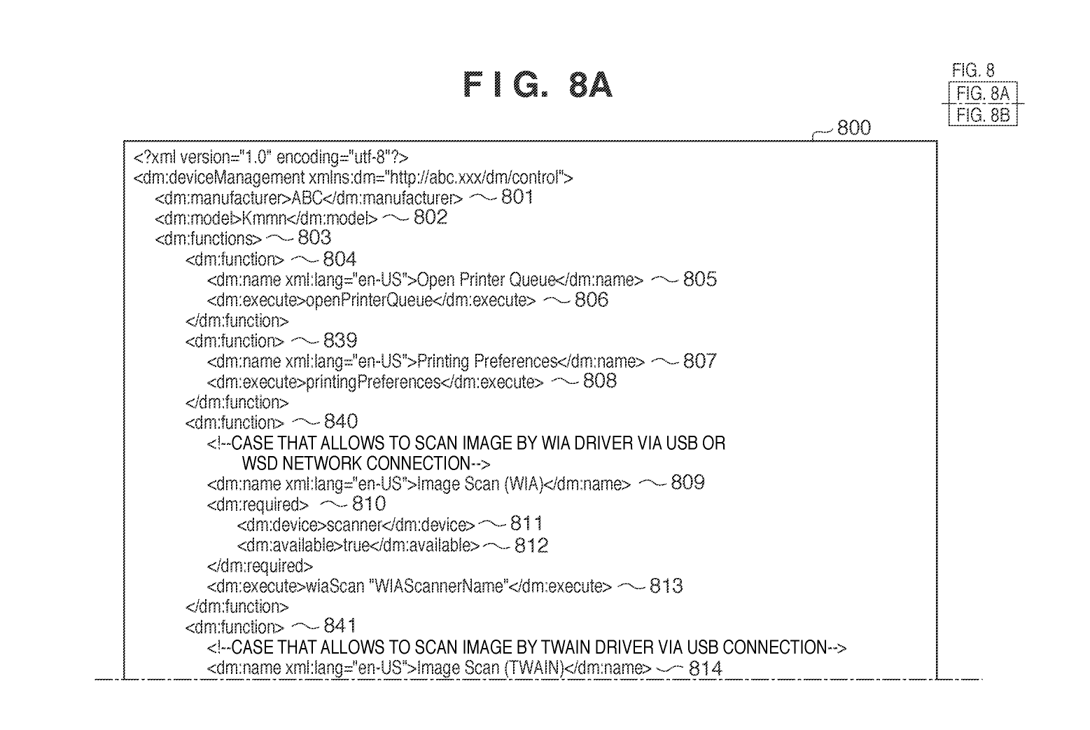

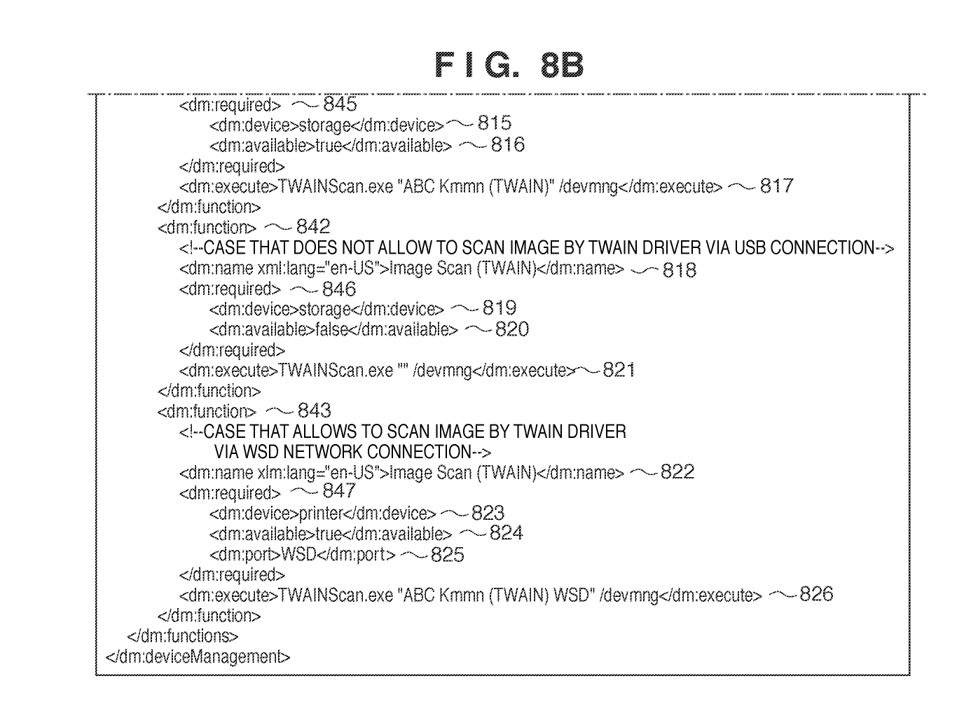

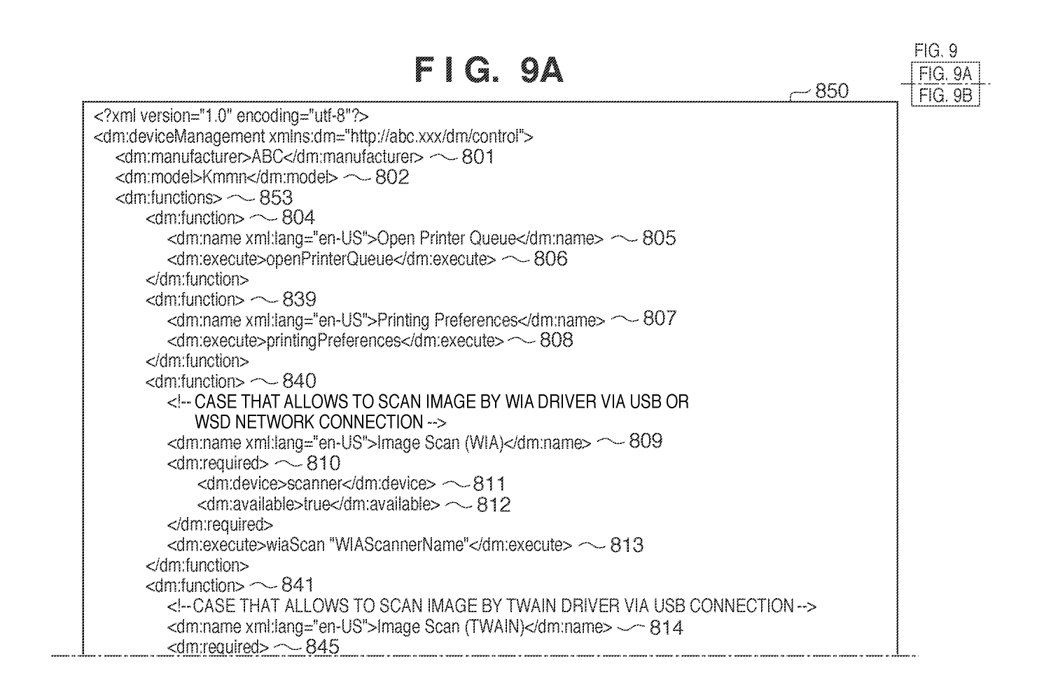

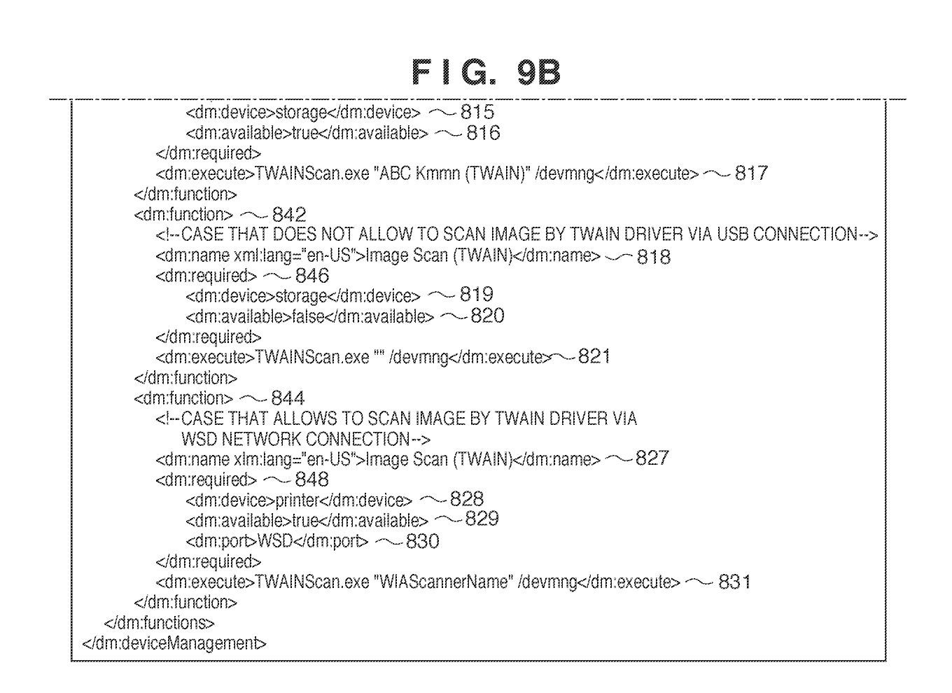

Each of the MFPs 3, 777, and 888 has a hardware arrangement, as will be described later using FIG. 2B, and they are connected to the PC 1 via a USB interface 14 and the network 4, so that these MFPs can make two-way communications with the PC 1. An application 80 is a device management program configured by an executable format file (*.EXE) for Windows. The running device management program is logically abstracted as a peripheral device management function unit which manages peripheral devices. As an example of an application of the present invention, the application 80 has a function of displaying a device management screen shown in FIG. 5B. An application 142 is a TWAIN-compatible application program, which will be described later using FIG. 6B. An execution file name of the TWAIN application 142 is “TWAINScan.exe”. A TWAIN driver 141 is a driver program, which will be described later using FIG. 7B. The network 4 is a general home network established in home lived in by the user (customer) who uses the MFPs 3, 777, and 888 and an MFP 7 (to be described later). The MFPs 3, 777, 888, and 7 are connected to the PC 1 via the network 4 in this home, and are shared by family members. The network 8 is an office network established in the ABC company. The PC 2 connected to the network 8 includes a Web server 9 which has a Web server function, and provides a Web site of the ABC company via the Internet. A CD-ROM 10 is a recording medium which can be inserted into the PC 1, and stores software and digital files. Note that the embodiment of the present invention has described the CD-ROM as an example of such storage medium, but an arbitrary storage medium such as a DVD-ROM can be used. File storage units 11 and 12 are included in the Web server 9 and CD-ROM 10, and store device management control files 800 and 850, which will be described later using FIGS. 8 and 9. The device management control files 800 and 850 are delivered from the file storage unit 11 and a recording medium such as the CD-ROM 10. An analog telephone line 5 is used to send or receive a facsimile document via the MFP 3 in the PC 1. A flash memory 6 can be referred to as a storage from the PC 1 when it is attached to a flash memory slot (not shown in FIG. 1) of the MFP 3. The MFP 7 has a model name “Defg” available from an XYZ company and a serial number “XXYYZZ001224”, and is a device quite different from the MFP 3. The serial number of this MFP uses a MAC address intact.

For a device (for example, a scanner) controlled via WIA, WIA drivers 703 and 704 and a WIA application 143 are also installed in the PC 1. The WIA drivers include a common WIA driver 703 provided by the operating system and an IHV WIA driver 704 provided by a hardware vendor.

<Hardware of PC and MFP>

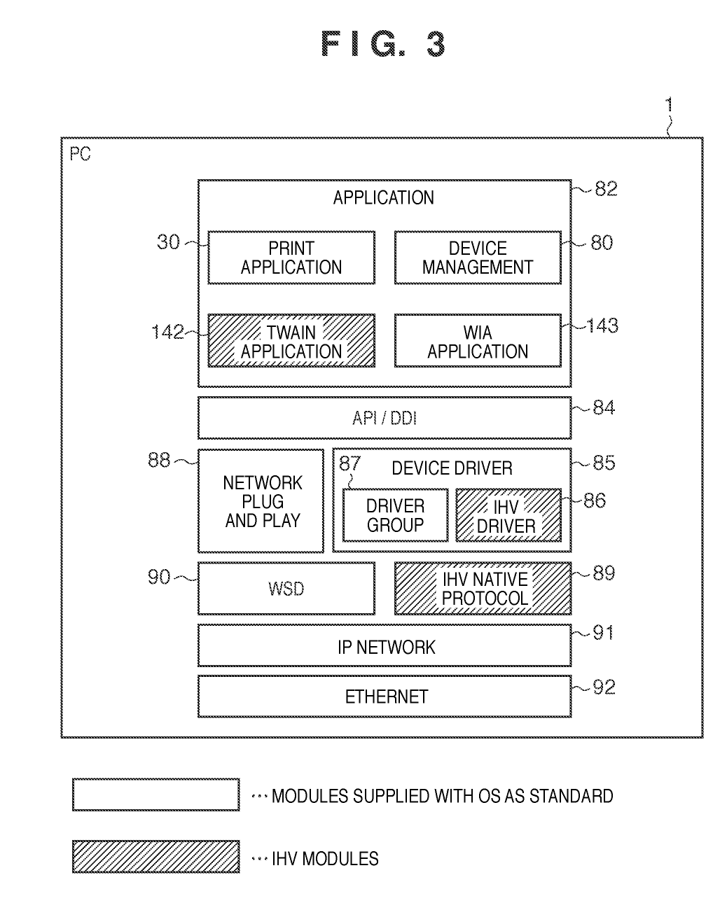

FIGS. 2A and 2B are block diagrams showing examples of the hardware arrangements of the PC and MFP. Each of the PCs 1 and 2 has a hardware arrangement shown in FIG. 2A. The PC 1 will be exemplified using FIG. 2A. As shown in FIG. 2A, the PC 1 has a random access memory unit (RAM 201), a hard disk drive unit (HDD 202) as a storage unit, a keyboard unit (KBD 203) as an example of an input unit, a CPU 204 as a control unit, a display (LCD 205) as an example of a display unit, a network board (NB 207) as an example of a communication control unit, and a bus 206 which interconnects the aforementioned components of the PC 1. A USB port for the USB interface 14 is included in the NB 207. Note that the storage unit may include, for example, a portable CD-ROM or internal ROM. Applications such as the device management program 80 and TWAIN application 142 and respective modules (software) shown in FIGS. 3, 4, 7A, 7B, and 14 are stored in the HDD 202, and they are read out onto the RAM 201 and are executed by the CPU 204 as needed. Thus, the CPU 204 implements functions of the applications such as the device management program 80 and TWAIN application 142 and the respective modules (software) shown in FIGS. 3, 4, 7A, 7B, and 14. Note that the device management program 80 will be simply referred to as “device management 80” hereinafter. The device management program will also be referred to as a peripheral device management program hereinafter.

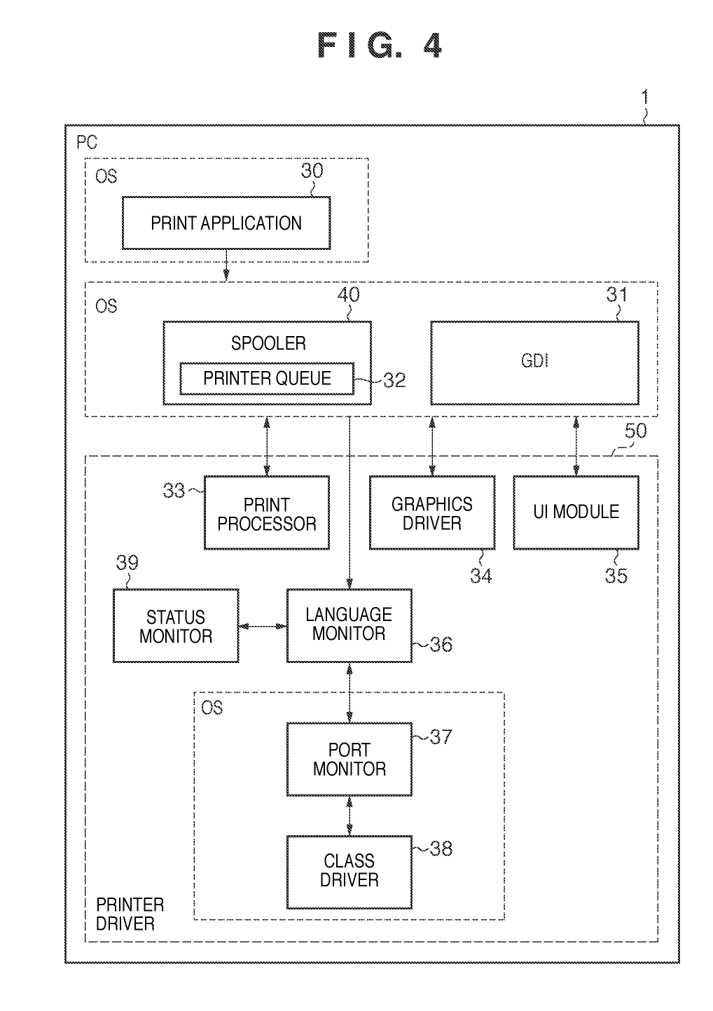

Each of the MFPs 3, 777, and 888 has a hardware arrangement shown in FIG. 2B. The MFP 3 will be exemplified using FIG. 2B. Referring to FIG. 2B, a CPU 15 is a central processing unit of the MFP 3, which is configured by, for example, a microprocessor. The CPU 15 controls a RAM 17, communication unit 18, printing unit 19, operation unit 20, display unit 21, scanning unit 22, facsimile control unit 23, and external storage control unit 24 according to programs stored in a ROM 16. The ROM 16 stores programs required for the MFP 3 to execute recording (printing) processing and processing for notifying the PC 1 of a printing operation status under the control of a printer driver 50 (to be described later using FIG. 4). The ROM 16 also stores programs required for the MFP 3 to execute facsimile sending/receiving processing and processing for notifying the PC 1 of a facsimile sending or receiving status under the control of a FAX driver (not shown). Furthermore, the ROM 16 stores programs required for the MFP 3 to execute image scanning processing and processing for notifying the PC 1 of a scanning operation status under the control of the WIA driver 704 or TWAIN driver 141. The RAM 17 temporarily stores print data, which is mainly sent from the PC 1 and is printed by the printing unit 19. Also, the RAM 17 temporarily stores, for example, image data scanned by the scanning unit 22, facsimile sending data sent from the PC 1, and facsimile receiving data received by the facsimile control unit. The communication unit 18 includes connection ports for the USB interface 14 and network 4, and that for the analog telephone lien 5, and controls USB, Ethernet, and facsimile analog communications.

The printing unit 19 is configured by a printer unit which includes an ink-jet print head, color inks, carriage, and print sheet convey mechanism, and an electric circuit which includes an ASIC required to control the print head to generate print pulses based on the print data. In response to a print operation or facsimile sending operation on an application which can issue a print instruction, display contents (image data) of a file opened by the application are temporarily stored in the HDD 202 of the PC 1 as a spool file of an EMF format. The spool file is converted into print data or facsimile sending data including MFP 3 control commands via the printer driver 50 or FAX driver, and the converted data is then sent to the MFP 3 via the USB interface 14 or network 4. The print data received by the MFP 3 is converted into print pulses by the printing unit 19, and is printed on a print sheet. The facsimile sending data received by the MFP 3 is converted into a facsimile communication protocol by the facsimile control unit 23, and is then sent to a destination facsimile apparatus via the analog telephone line 5.

The operation unit 20 includes various buttons such as a power button and reset button, and allows the user to operate the MFP 3. The display unit 21 includes a liquid crystal display used as a touch panel, and can display a status of the MFP 3, and can display and input various settings and telephone numbers. The scanning unit 22 is configured by a color image sensor and an electric circuit including an ASIC for image processing, and controls a scanner function. The facsimile control unit 23 is configured by, for example, a facsimile modem and analog communication circuit, and controls facsimile sending and receiving operations according to the facsimile communication protocol. The external storage control unit 24 is configured by, for example, a flash memory slot and storage interface circuit, and controls an attached flash memory.

<Software of PC>

FIG. 3 shows the software configuration of the PC. Referring to FIG. 3, an Ethernet control stack 92 is a program required to control Ethernet. An IP network control stack 91 is a program required to control an IP network. A WSD control stack 90 is a program required to control WSD. An IHV native protocol control stack 89 is a program required to control an IHV unique protocol. An N-PnP control stack 88 is a program required to control a network plug and play function (to be also abbreviated as N-PnP hereinafter). As standard functions of the Windows 7 OS as a series of plug and play extension functions which provide supports for network-connection devices, Plug and Play Extensions (PnP-X) are available. However, this embodiment considers the PnP-X function as a function equivalent to the N-PnP function, and will exemplify a case using the N-PnP function. A device driver group 85 includes a standard driver group 87 supplied with the OS as standard drivers, and an IHV (Independent Hardware Vendor) driver group 86 provided from IHVs. An application/DDI interface 84 includes an application programming interface (API) and device driver interface (DDI). The application 80 is a utility program for device management, which is supplied with the OS as a standard program. This program will also be simply referred to as “device management” hereinafter. An application 30 is an application program which can issue a print instruction, as will be described later using FIG. 4. The application 142 is a TWAIN-compatible application, which will be described later using FIG. 6B. The application 143 is a WIA-compatible application, which will be described later using FIG. 6A. An application group 82 includes the device management 80, and applications 30, 142, and 143. The device management 80 can manage, execute, and display a [Devices and Printers] folder 500, which will be described later using FIG. 5A, and a device management screen 600, which will be described later using FIG. 5B, via, for example, the application/DDI interface 84. Note that a folder is a data structure required to hold objects (for example, files and folders) which belong to that folder, together in a file storage such as a hard disk. FIG. 5A shows an example of a user interface in place of the folder itself, and this embodiment will denote the user interface using the same reference numeral as that of the folder. Also, as in FIG. 5A, a representative user interface (for example, a user interface displayed first at the time of execution) provided by a program will be denoted by the same reference numeral as that of the program throughout the present specification.

<Configuration of Printer Driver>

FIG. 4 shows the configuration of a printer driver in the PC. Referring to FIG. 4, the driver 50 is a printer driver for the MFP 3, which is installed in the PC 1, and includes a plurality of modules 33 to 36 and 39. The application 30 having a print function corresponds to, for example, “Notepad (Notepad.exe)” as a text editor supplied with the OS as a standard program. A Graphics Device Interface (GDI) 31 is a part of the OS. A printer queue 32 is configured as a part of a spooler 40, and stores a queue of print jobs. A print processor 33 executes print layout change processing and special processing for a print image. A graphics driver 34 executes image processing for printing based on rendering commands sent from the GDI 31 as a core of image processing of the printer driver 50, and generates print control commands. A UI module 35 provides and controls a user interface of the printer driver 50. A language monitor 36 controls data sending/receiving processing as a communication interface of data. A status monitor 39 displays statuses such as ink remaining amounts, alerts, and errors of the MFP 3. A port monitor 37 executes processing for sending data received from the language monitor 36 to an appropriate port, and receiving data received from the MFP 3 via a class driver 38. The class driver 38 is a low-level module closest to a port. In this embodiment, the class driver 38 corresponds to a printer-class driver of the WSD or IHV unique protocol, and controls the port (USB or network port in this embodiment). The printer driver 50 is available from the ABC company as a manufacturer of the MFP 3.

<[Devices and Printers] and Device Management Screen>

FIGS. 5A and 5B respectively show the [Devices and Printers] folder and device management screen. FIG. 5A is displayed when the user makes an operation to select and open the [Devices and Printers] folder. In FIG. 5A, the [Devices and Printers] folder 500 is displayed on the display screen of the PC 1, and displays peripheral devices (for example, a printer and FAX) usable in the PC 1 for respective drivers. In this embodiment, this screen displays a device 501 having a name “XYZ Defg” and a device 503 having a name “ABC Kmmn” as usable devices. A default mark 502 indicates a default device of the system, and FIG. 5A shows a state in which the device 501 is set as a default device. Note that the default device can also be called a default driver since it is displayed for each driver, as described above, and indicates a driver of the default device. The [Devices and Printers] folder 500 represents that the device 501 whose icon is indicated by the dotted line is unusable, and the device 503 whose icon is indicated by the solid line is usable.

In FIG. 5B, the device management screen 600 is launched and displayed when a device in the [Devices and Printers] folder 500 shown in FIG. 5A is selected. FIG. 5B shows an example in which the device 503 is selected. The user can manage the MFP 3 using this device management screen 600. The device management screen 600 displays a device icon 601, device name 602, and manufacturer information 603 on its upper portion. Data of the device icon 601 is held as a part of a device management control file storage module 905 (although not shown). As the device name 602, the device name of the device 503 on the [Devices and Printers] folder 500 is displayed. Also, as the manufacturer information 603, a character string designated in a <dm:manufacturer> element 801 shown in FIG. 8 or 9 is displayed. On a lower portion of the device management screen 600, links to functions associated with the device 503 are displayed. In the example of FIG. 5B, a printer queue button 604, printing preferences button 605, image scan (WIA) button 610, and image scan (TWAIN) button 611 are displayed. <dm:functions> elements 803 and 853 shown in FIGS. 8 and 9 describe <dm:function> elements 804, 839, 840, 841, 842, 843, and 844 which represent respective buttons and functions. The image scan (TWAIN) button 611 is set with different arguments upon launching of the TWAIN application 142 depending on connection states between the PC 1 and MFP 3.

<Selection of Driver>

FIGS. 6A, 6B, and 6C show user interfaces (UIs) respectively provided by the WIA application 143 and TWAIN application. Referring to FIG. 6A, a user interface 143 is a main dialog of the OS-standard WIA application 143. Note that this embodiment denotes a representative user interface provided by a program using the same reference numeral as that of the program, as described above. The WIA application 143 is software which can scan an image using the scanner of the MFP 3 in cooperation with, for example, the common WIA driver 703 or IHV WIA driver 704 shown in FIG. 7A. A scanner selection field 620 allows the user to select a WIA driver installed in the PC 1 as a scanner (driver) used to scan an image. FIG. 6A exemplifies a state in which “Kmmn (WIA)” is selected. A scanner (driver) can be selected on a scanner selection dialog 622 (to be described below using FIG. 6C), which is displayed upon pressing of a scanner change button 624.

FIG. 6C shows an example of the scanner selection dialog. In FIG. 6C, the dialog 622 is an OS-standard scanner selection dialog. A scanner selection field 623 displays a list of WIA drivers installed in the PC 1, and allows the user to select a driver to be used from the list. When the user selects the WIA driver, he or she can designate a scanner (driver) which is used by the WIA application 143, and is required to scan an image. In FIG. 6C, the user can select one of the following drivers as a scanner.

Kmmn (WIA)

Kmmn (WIA)_AABBCCXX0814

Kmmn (WIA)_AABBCCXX0707

Mnmk (WIA)_YY1218YY0730

Defg (WIA)_XXYYZZ001224

“Kmmn (WIA)” represents a choice of the IHV WIA driver 704 for a scanner which is connected to the PC 1 via the USB interface 14 and has a model name “Kmmn”. In the example of FIG. 1, the IHV WIA driver 704 is installed for the MFP 3, and the above choice corresponds to this driver. “Kmmn (WIA)_AABBCCXX0814”, “Kmmn (WIA)_AABBCCXX0707”, “Mnmk (WIA)_YY1218YY0730”, and “XYZ Defg (WIA)_XXYYZZ001224” represent choices of the OS-standard common WIA drivers 703 for scanners, which are connected to the PC 1 via the WSD network 4. In the example of FIG. 1, the WIA drivers 703 are installed for the MFPs 3, 777, 888, and 7, and the above choices respectively correspond to these drivers. That is, the MFP 7 in FIG. 1 is connected to the PC 1 via two interfaces including the USB and network, and drivers for these interfaces are installed for the scanner of the MFP 7. Note that FIG. 6C shows a state in which “Kmmn (WIA)” is selected.

In case of the WIA using a WSD protocol via the network, a WIA driver name assigned to a device is a name <model name>_<serial number> including a model name and serial number of that device. In the WSD protocol, metadata (<mex:Metadata> element 223) to be described later using FIG. 19 includes information of the model name and serial number of the device, and the OS decides and assigns a WIA driver name for that device based on these pieces of information.

In FIG. 6B, the TWAIN application 142 available from the ABC company is software which can scan an image using the scanners of the MFPs 3, 777, and 888 in cooperation with the TWAIN driver 141 shown in FIG. 7B. FIG. 6B shows a main dialog of the TWAIN application 142. A scanner selection field 621 allows the user to select a TWAIN driver installed in the PC 1 as a scanner (driver) used to scan an image. In this embodiment, the user can select one of the following drivers.

ABC Kmmn (TWAIN)

ABC Kmmn (TWAIN)_AABBCCXX0814

ABC Kmmn (TWAIN)_AABBCCXX0707

ABC Mnmk (TWAIN)_AABBCCYY0730

In this case, “ABC Kmmn (TWAIN)” represents a choice of the TWAIN driver 141 available from the ABC company for a scanner connected to the PC 1 via the USB interface 14. In the example of FIG. 1, the TWAIN driver 141 is installed for the MFP 3, and the above choice corresponds to this driver. “ABC Kmmn (TWAIN)_AABBCCXX0814”, “ABC Kmmn (TWAIN)_AABBCCXX0707”, and “ABC Mnmk (TWAIN)_AABBCCYY0730” represent choices of the TWAIN drivers 141 for scanners, which are connected to the PC 1 via the WSD network 4. In the example of FIG. 1, these TWAIN drivers 141 are respectively installed for the MFPs 3, 777, and 888, and these choices correspond to these drivers. As described above, the choices of the TWAIN drivers 141, which are installed via the network 4 and are respectively assigned to the MFPs 3 and 777, have names “<model name>_<serial number>” like “ABC Kmmn (TWAIN)_************”. Also, the choice of the TWAIN driver 141, which is installed via the network 4 and is assigned to the MFP 888, similarly has a name “ABC Mnmk (TWAIN)_************”. In this case, a serial number of a device is assigned to a part “************”, and in this embodiment, this serial number is configured using a MAC address uniquely assigned to hardware of the communication unit 18. FIG. 6B shows a state in which “ABC Kmmn (TWAIN)” is selected. The TWAIN application 142 executes control associated with scanning of an image such as an image (document) scanning operation using the TWAIN driver selected on the scanner selection field 621 by a scanner (MFP) to which that TWAIN driver is assigned.

The TWAIN application 142 has a function of designating a default scanner (driver) to be selected at the launch timing of the application and a launch source using the following arguments at the launch timing.

First argument: TWAIN driver name

Second argument: launch source

/devmng . . . launched from the device management screen

/other . . . launched from a position other than the device management screen

As the launch source, the above two values can be set in this example.

<Parameter Example at Driver Launch Timing>

Some parameter examples at the driver launch timing will be described below.

### Example 1

### TWAINScan.exe “ABC Kmmn (TWAIN)”/devmng

This example corresponds to a case in which the TWAIN application 142 is launched from the device management screen 600, and an image is scanned by the MFP 3 using the TWAIN driver 141 via a USB connection.

### Example 2

### TWAINScan.exe “ABC Kmmn (TWAIN) WSD”/devmng

This example corresponds to a case in which the TWAIN application 142 is launched from the device management screen 600, and an image is scanned by the MFP 3 or 777 using the TWAIN driver 141 via a WSD network connection.

### Example 3

### TWAINScan.exe “ABC Kmmn (TWAIN) Network”/devmng

This example corresponds to a case in which the TWAIN application 142 is launched from the device management screen 600, and an image is scanned by the MFP 3 or 777 using the TWAIN driver 141 via a network connection of an IHV native protocol.

### Example 4

### TWAINScan.exe “ABC Kmmn (TWAIN)_************”/other

This example corresponds to a case in which the TWAIN application 142 is launched from a position such as a command line (not shown) other than the device management screen 600, and an image is scanned by the MFP 3 or 777, which includes hardware of the communication unit 18 having a MAC address “************” using the TWAIN driver 141 via a WSD network connection.

In examples 2 and 4, both of the first argument indicating the TWAIN driver name and the second argument indicating the launch source have different values. This embodiment focuses attention especially on the first argument. When the device management screen 600 cannot acquire any MAC address like in a case in which the TWAIN application 142 is launched from the device management screen 600, as will be described later, “ABC Kmmn (TWAIN) WSD” is set as the first argument to launch the TWAIN application 142, as shown in example 2. By contrast, when the user can acquire a MAC address and can designate the first argument using that value like in a case in which the TWAIN application 142 is launched from a command line (not shown), “ABC Kmmn (TWAIN)_************” is set as the first argument to launch the TWAIN application 142, as shown in example 4.

### Example 5

### TWAINScan.exe “ABC Kmmn (TWAIN)”/other

This example corresponds to a case in which the TWAIN application 142 is launched from a position such as a command line (not shown) other than the device management screen 600, and an image is scanned by the MFP 3 using the TWAIN driver 141 via a USB connection.

In examples 1 and 5, only the second argument indicating the launch source has different values. Using this second argument, the TWAIN application 142 can switch processing at the launch timing or that after launching according to the launch source, thus improving the user's operability. Since the TWAIN application 142 is launched by appending the first argument, a scanner (driver) used to scan an image can be designated in place of selection and designation of it on the scanner selection field 621.

### Example 6

### TWAINScan.exe “ABC Mnmk (TWAIN) WSD”/devmng

This example corresponds to a case in which the TWAIN application 142 is launched from the device management screen 600, and an image is scanned by the MFP 888 using the TWAIN driver 141 via a WSD network connection.

### Example 7

### TWAINScan.exe “ABC Mnmk (TWAIN)_************”/other

This example corresponds to a case in which the TWAIN application 142 is launched from a position such as a command line (not shown) other than the device management screen 600, and an image is scanned by the MFP 888 using the TWAIN driver 141 via a WSD network connection.

<Software of PC 1>

FIGS. 7A and 7B show the software configuration of the PC. In FIGS. 7A and 7B, a driver 705 is an OS-standard kernel I/O driver. FIG. 7A shows the software configuration required to scan an image by the MFP 3 using the WIA application 143. The application 143 is an OS-standard WIA application shown in FIG. 6A. A driver 703 is an OS-standard common WIA driver, and a driver 704 is an IHV WIA driver available from the manufacturer (ABC company). An OS-standard STI/WIA service 702 is an interface between the WIA application 143 and the WIA drivers 703 and 704.

FIG. 7B shows the software configuration required to scan an image by the MFP 3 using the TWAIN application 142. The application 142 is a TWAIN application available from the manufacturer (ABC company) shown in FIG. 6B. A TWAIN data source manager 707 is a program supplied with the OS as a standard program. The driver 141 is a TWAIN driver available from the manufacturer (ABC company). A TWAIN data source for the MFP 3 is included in the TWAIN driver 141. In FIGS. 7A and 7B, hatched programs are IHV programs, that is, those provided from the vendor, and non-hatched programs are those which are supplied with the OS.

<Device Management Control File>

FIG. 8 shows the contents of the device management control file 800. The device management control file 800 is that for English. Information shown in FIG. 8 is stored in the file storage unit 11 or 12. In FIG. 8, the name of the ABC company as the manufacturer of the device (MFP 3) is set in a <dm:manufacturer> element 801. The model name “Kmmn” of the device (MFP 3) is set in a <dm:model> element 802. These pieces of information are used when the device management control file 800 is installed. The device management control file 800 also describes pieces of information required to configure the device management screen 600. In order to display the printer queue button 604, printing preferences button 605, image scan (WIA) button 610, and image scan (TWAIN) button 611 shown in FIG. 5B on the device management screen 600 which is launched and displayed when the MFP 3 is connected to the PC 1, <dm:function> elements 804, 839, 840, 841, 842, and 843 which represent the respective buttons and functions are set in a <dm:functions> element 803. Note that “dm” before an element name indicates a name space. However, in this embodiment, since all elements are defined on a dm name space, “dm” is omitted in some cases.

In the <dm:function> element 804, a character string “Open Printer Queue” displayed on the printer queue button 604 is set in a <dm:name xml:lang=“en-US”>Open Printer Queue</dm:name> element 805. In a <dm:execute>openPrinterQueue</dm:execute> element 806, a code “openPrinterQueue” which represents a function (program) required to display a printer queue folder is set. Although not shown, the printer queue folder has a function of displaying a print job status. The “name” and “execute” elements are referred to upon determination of processing to be executed according to, for example, the display contents and operations shown in FIG. 5B. In this example, when a program to be executed is the TWAIN application, a corresponding function is implemented by executing, for example, a sub-program specified by a program name described in an “execute” element.

In the <dm:function> element 839, a character string “Printing Preferences” displayed on the printing preferences button 605 is set in a <dm:name xml:lang=“en-US”>Printing Preferences</dm:name> element 807. In a <dm:execute>printingPreferences</dm:execute> element 808, a code “printingPreferences” which represents a function (program) required to display a printing preferences dialog is set. Although not shown, the printing preferences dialog represents a print setting screen included in the UI module 35 of the printer driver 50.

In the <dm:function> element 840, a character string “Image Scan (WIA)” displayed on the image scan (WIA) button 610 is set in a <dm:name xml:lang=“en-US”>Image Scan (WIA)</dm:name> element 809. In a <dm:required> element 810, information which represents a condition required to display the image scan (WIA) button 610 is set. A <dm:device>scanner</dm:device> element 811 represents that a device connected to the PC 1 via the USB interface 14 or WSD network 4 includes a scanner function using the WIA driver 704 or 703. A <dm:available> true</dm:available> element 812 represents that the scanner function using the WIA driver 704 or 703 is available in the device connected to the PC 1 via the USB interface 14 or WSD network 4. That is, the condition represented by the <dm:required> element 810 indicates that an image can be scanned using the WIA driver 704 or 703 via a USB or WSD network connection. In a <dm:execute>wiaScan “WIAScannerName”</dm:execute> element 813, a code [“wiaScan “WIAScannerName”] which represents a function (program) required to launch the WIA application 143 is set. In this case, “WIAScannerName” is a variable which represents a WIA driver name assigned to the MFP 3. When the MFP 3 is connected to the PC 1 via the USB interface 14, the WIA driver name of the WIA driver 704 is substituted in this variable. On the other hand, when the MFP 3 is connected to the PC 1 via the WSD network 4, the driver name of the WIA driver 703 is substituted in this variable.

In the <dm:function> element 841, a character string “Image Scan (TWAIN)” displayed on the image scan (TWAIN) button 611 is set in a <dm:name xml:lang=“en-US”>Image Scan (TWAIN)</dm:name> element 814. In a <dm:required> element 845, information which represents a condition required to display the image scan (TWAIN) button 611 is set. A <dm:device>storage</dm:device> element 815 represents that a device connected to the PC 1 via the USB interface 14 includes a storage function. A <dm:available>true</dm:available> element 816 represents that the storage function of the device connected to the PC 1 via the USB interface 14 is available. It is a common practice to use the <dm:required> element 810 to discriminate whether or not the scanner function of the device (MFP 3) connected to the PC 1 is available. However, the Windows 7 OS cannot execute automatic switching control which discriminates a USB connection and WSD network connection and executes appropriate control according to the discriminated connection in the scanner function using the TWAIN driver 141, when the <dm:required> element 810 is used. Therefore, in the <dm:required> element 810, appropriate values which match respective interfaces according to the interfaces of the PC 1 and MFP 3 cannot be set as an argument upon launching the TWAIN application 142. Hence, since the scanner function is discriminated by specifying an interface between the PC 1 and device (MFP 3) using a “state in which the storage function is available” as another function which is not related to the scanner function, as represented by the <dm:required> element 845, appropriate information is set as an argument upon launching the TWAIN application 142, thus improving the user's operability. In this manner, the condition represented by the <dm:required> element 845 corresponds to a case in which an image can be scanned via a USB connection by the TWAIN driver. In a <dm:execute>TWAINScan.exe “ABC Kmmn (TWAIN)” /devmng</dm:execute> element 817, a code [TWAINScan.exe “ABC Kmmn (TWAIN)”/devmng] which represents a function (program) required to launch the TWAIN application 142 is set. Thus, when the image scan (TWAIN) button 611 is pressed, the TWAIN application 142 is launched while “ABC Kmmn (TWAIN)” which represents the USB-connection TWAIN driver 141 is set as a default scanner (driver).

In the <dm:function> element 842, a character string “Image Scan (TWAIN)” displayed on the image scan (TWAIN) button 611 is set in a <dm:name xml:lang=“en-US”>Image Scan (TWAIN)</dm:name> element 818. In a <dm:required> element 846, information which represents a condition required to display the image scan (TWAIN) button 611 is set. A <dm:device>storage</dm:device> element 819 represents that a device connected to the PC 1 via the USB interface 14 includes a storage function. A <dm:available>false</dm:available> element 820 represents that the storage function of the device connected to the PC 1 via the USB interface 14 is not available. It is a common practice to use

<dm:required>
<dm:device>scanner</dm:device>
<dm:available>false</dm:available>
</dm:required>

to discriminate whether or not the scanner function of the device (MFP 3) connected to the PC 1 is not available. However, the Windows 7 OS cannot execute automatic switching control which discriminates a USB connection and WSD network connection and executes appropriate control according to the discriminated connection in the scanner function using the TWAIN driver 141, when this <dm:required> element is used. Therefore, in this <dm:required> element, appropriate values which match respective interfaces according to the interfaces of the PC 1 and MFP 3 cannot be set as an argument upon launching the TWAIN application 142. Hence, since the scanner function is discriminated by specifying an interface between the PC 1 and device (MFP 3) using a “state in which the storage function is not available” as another function which is not related to the scanner function, as represented by the <dm:required> element 846, appropriate information is set as an argument upon launching the TWAIN application 142, thus improving the user's operability. In this manner, the condition represented by the <dm:required> element 846 corresponds to a case in which an image cannot be scanned by the TWAIN driver via a USB connection and, for example, a case in which the PC 1 and MFP 3 are not connected via the USB interface 14 or network 4. In such case, information required to form an image scan (TWAIN) button 611 for an unknown device, which button is used to launch the TWAIN application 142, is set. In a <dm:execute>TWAINScan.exe “ ” /devmng</dm:execute> element 821, a code [TWAINScan.exe “ ”/devmng] which represents a function (program) required to launch the TWAIN application 142 is set.

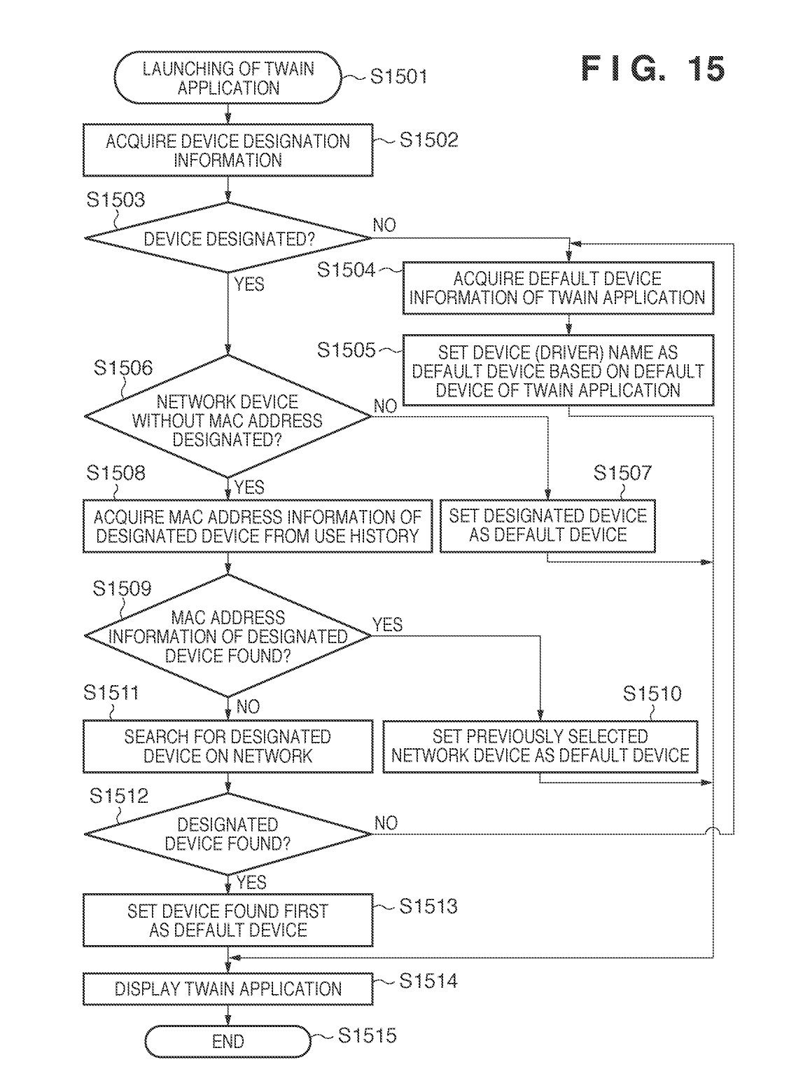

In the <dm:function> element 843, a character string “Image Scan (TWAIN)” displayed on the image scan (TWAIN) button 611 is set in a <dm:name xml:lang=“en-US”>Image Scan (TWAIN)</dm:name> element 822. In a <dm:required> element 847, information which represents conditions required to display the image scan (TWAIN) button 611 is set. A <dm:device>printer</dm:device> element 823 represents that a device connected to the PC 1 includes a printer function. A <dm:available>true</dm:available> element 824 represents that the printer function of the device connected to the PC 1 is available. A <dm:port>WSD</dm:port> element 825 represents that a port required to use the printer function of the device is a WSD port. In this case, the WSD port is a WSD network-connection port. Note that the <dm:port>WSD</dm:port> element 825 is defined as an OS standard function. It is a common practice to use the <dm:required> element 810 to discriminate whether or not the scanner function of the device (MFP 3) connected to the PC 1 is available. However, the Windows 7 OS cannot execute automatic switching control which discriminates a USB connection and WSD network connection and executes appropriate control according to the discriminated connection in the scanner function using the TWAIN driver 141, when the <dm:required> element 810 is used. Therefore, in the <dm:required> element 810, appropriate values which match respective interfaces according to the interfaces of the PC 1 and MFP 3 cannot be set as an argument upon launching the TWAIN application 142. Hence, the scanner function is discriminated by specifying an interface between the PC 1 and device (MFP 3) using a “state in which the printer function is available” as another function which is not related to the scanner function and “port name of the printer function”, as represented by the <dm:required> element 847. Then, appropriate information is set as an argument upon launching the TWAIN application 142, thus improving the user's operability. In this way, the conditions represented by the <dm:required> element 847 correspond to a case in which an image can be scanned by the TWAIN driver via a WSD network connection. In a <dm:execute>TWAINScan.exe “ABC Kmmn (TWAIN) WSD” /devmng</dm:execute> element 826, a code [TWAINScan.exe “ABC Kmmn (TWAIN) WSD”/devmng] which represents a function (program) required to launch the TWAIN application 142 is set. Thus, when the image scan (TWAIN) button 611 is pressed, the TWAIN application 142 is launched while “ABC Kmmn (TWAIN) WSD” which represents the WSD network-connection TWAIN driver 141 is set as a default scanner (driver). As described above, since the TWAIN application 142 can be launched while the appropriate TWAIN driver is selected, as shown in FIG. 15, high user's operability is assured.

The device management control file is prepared in advance in accordance with a device, and is saved in, for example, a nonvolatile memory included in the device so that the file can be read out from the PC 1. Then, when the PC 1 recognizes a connection of that device, it installs the device management control file by, for example, reading out that file from the device. Alternatively, the PC 1 may search device management control files, which are saved in advance in itself, for that of a newly connected device, and may install the file if it is found.

<Configurations of Device Management and TWAIN Application>

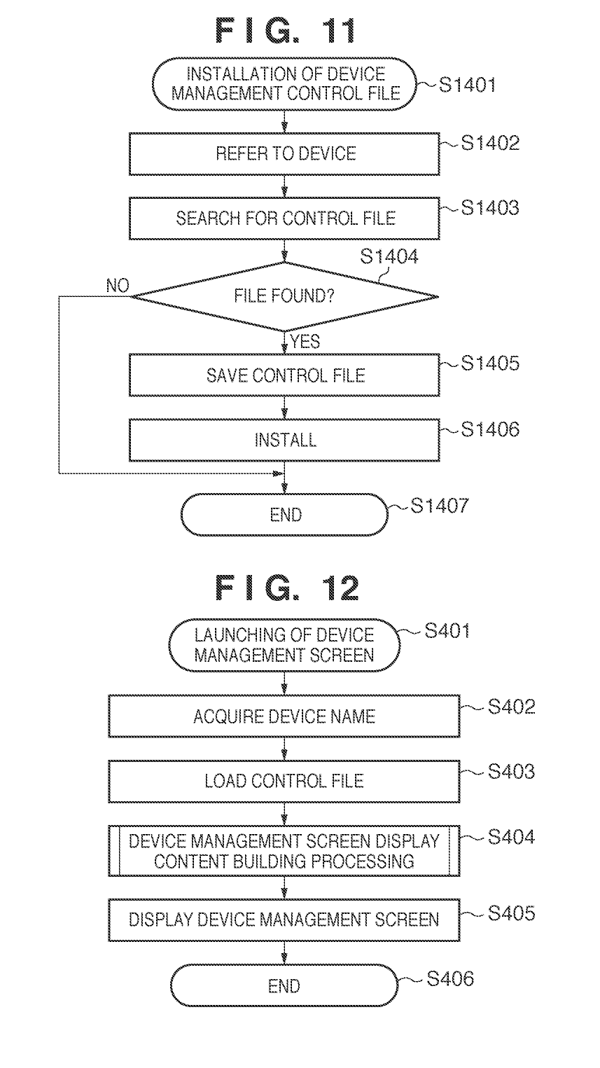

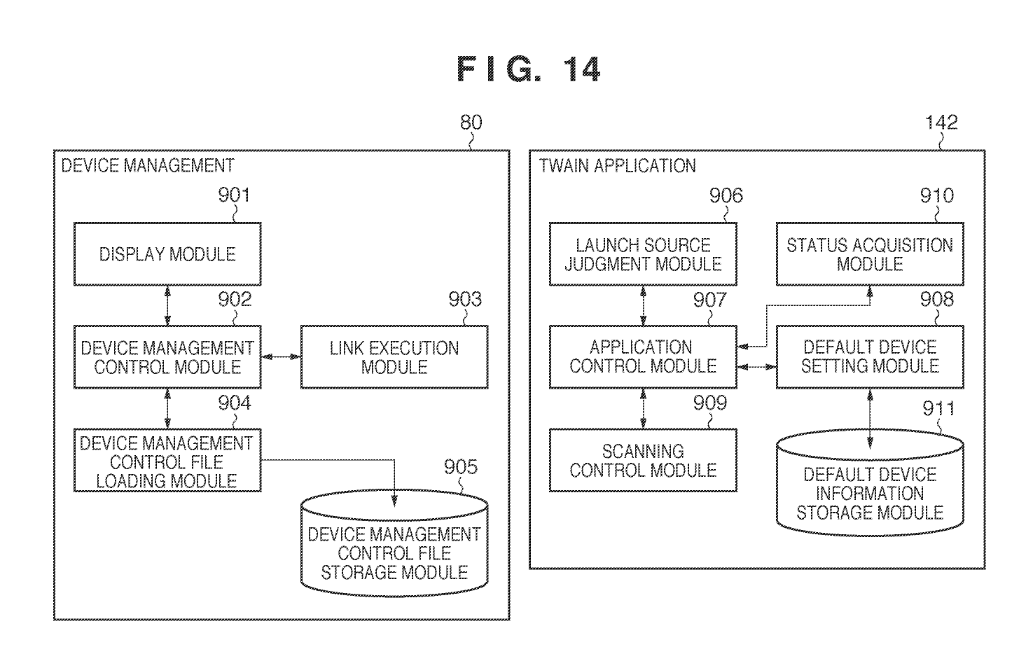

FIG. 14 shows the software configurations of the device management and TWAIN application. Referring to FIG. 14, the device management 80 has a display module 901, device management control module 902, link execution module 903, device management control file loading module 904, and device management control file storage module 905. The device management control file storage module 905 stores the device management control files 800 and 850 which are saved in step S1405 of FIG. 11 (to be described later) and are respectively shown in FIGS. 8 and 9. The TWAIN application 142 is configured by a launch source judgment module 906, application control module 907, default device setting module 908, scanning control module 909, status acquisition module 910, and default device information storage module 911. The device management screen 600 is launched and displayed when the MFP 3 is connected to the PC 1 via the USB interface 14 or network 4 or when a device in the [Devices and Printers] folder 500 shown in FIG. 5A is selected. In the following description, a case will be mainly exemplified wherein the device management screen 600 shown in FIG. 5B is launched and displayed when the MFP 3 is connected to the PC 1 via the USB interface 14 or network 4.

<Device Connection Sequence>

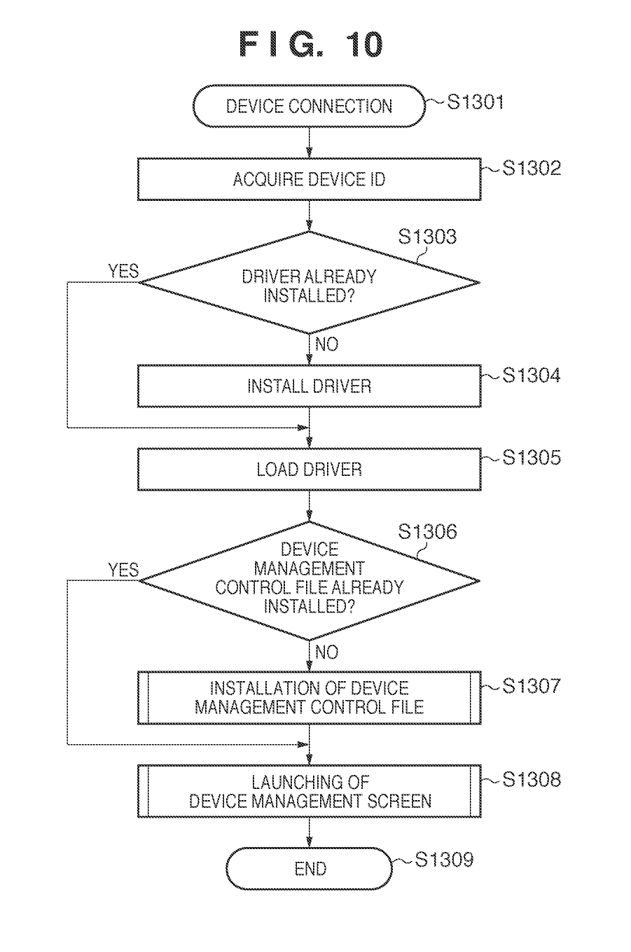

FIG. 10 is a flowchart showing processing upon connection of a device. A case will be exemplified below wherein the MFP 3 is connected as a new device. A program related to the flowchart shown in FIG. 10 is stored in the HDD 202, is read out onto the RAM 201, and is executed by the CPU 204. The sequence shown in FIG. 10 is executed as a part of the operating system. In FIG. 10, when a device (MFP 3) is connected to the PC (PC 1) via the USB interface 14 or network 4 (S1301), the PC 1 acquires a device ID (S1302). The device ID is expressed by, for example, a character string “MFG:ABC;MDL:Kmmn;CLS:PRINTER;CMD:K4;DES:ABC Kmmn;”. This device ID is that of the printer function of the MFP 3, which can be acquired by the PC 1 from the MFP 3 via the USB interface 14 or network 4, and represents the following pieces of information.

Manufacturer (MFG:): ABC

Model (MDL:): Kmmn

Class (CLS:): PRINTER

Command (CMD:) K4 (private print control command of the ABC company)

Description (DES:): ABC Kmmn

Next, the device management 80 checks if drivers have already been installed in the PC 1 (S1303). Drivers, the presence/absence of which is checked, are those of a device which is ready to be used by the PC 1 when the MFP 3 is connected, and include, for example, the printer driver 50, FAX driver, WIA driver 703 or 704, and TWAIN driver 141. If it is determined in step S1303 that drivers have not been installed yet, the OS installs drivers which have not been installed (S1304). The drivers are provided while being supplied with the operating system or are provided by the device vendor together with the device. In step S1304, these drivers are installed from the hard disk or recording medium or by downloading them from the network. After that, the OS loads the drivers (S1305). When the drivers are normally loaded, the device (MFP 3) is registered in the [Devices and Printers] folder 500 shown in FIG. 5A. Note that upon installation of a program, not only a program file of an executable format is saved, but also information indicating that the program is installed has to be registered in a database (registry) managed by the operating system. Hence, in this embodiment, assume that “to install a program” means copying of the program and registration of the program in the database. The same applies to installation of a data file.

Next, the device management 80 checks whether or not the device management control file 800 or 850 shown in FIG. 8 or 9 has already been installed in the PC 1 (S1306). In step S1306, it is determined whether or not the existing device management control file matches the drivers (printer driver 50, FAX driver, WIA driver 703 or 704, and TWAIN driver 141) installed in step S1304. In step S1306, whether or not the already installed device management control file matches the drivers is determined based on the manufacturer (MFG:) information and model (MDL:) information included in the device ID. If it is determined in step S1306 that the device management control file 800 or 850 has not been installed yet, the device management 80 executes device management control file installation processing to be described later using FIG. 11 (S1307). Then, the device management 80 executes device management screen launching processing to be described later using FIG. 12 (S1308), and ends the processing upon connection of the device (S1309).

On the other hand, if it is determined in step S1306 that the device management control file 800 or 850 has already been installed, the process jumps to step S1308. If it is determined in step S1303 that the drivers (printer driver 50, FAX driver, WIA driver 703 or 704, and TWAIN driver 141) have already been installed, the process jumps to step S1305.

<Installation Sequence of Device Management Control File>

FIG. 11 is a flowchart showing the device management control file installation processing (S1307). A program related to the flowchart shown in FIG. 11 is stored in the HDD 202, is read out onto the RAM 201, and is executed by the CPU 204. When the device management control file installation processing is executed in step S1307 in FIG. 10, the device management 80 starts that processing in FIG. 11 (S1401). The device management 80 refers to the device ID of the device (MFP 3) connected via the USB interface 14 or network 4 (S1402). The device ID is information which is acquired and saved in step S1302. The device management 80 searches for the device management control file 800 or 850 for the device (MFP 3) connected to the PC 1 based on the manufacturer (MFG:) information and model (MDL:) information included in this device ID (S1403). In the device management control file 800 or 850 in FIG. 8 or 9, the manufacturer (MFG:) “ABC” and model (MDL:) “Kmmn” corresponding to the device (MFP 3) are described in the <dm:manufacturer> element (that is, manufacturer element) 801 and <dm:model> element (that is, model element) 802. Based on pieces of information described in the elements 801 and 802, the device management 80 searches the file storage unit 11 of the Web server 9 or the file storage unit 12 of the CD-ROM 10 inserted in the PC 1 for the device management control file 800 or 850 for the device (MFP 3). That is, the device management 80 searches for the device management control file including the manufacturer element and model element which match the manufacturer (MFG:) information and model (MDL:) information. Then, the device management 80 checks whether or not the device management control file 800 or 850 is found from the file storage unit 11 or 12 (S1404). If it is determined in step S1404 that the device management control file 800 or 850 is found, the device management 80 saves that device management control file 800 or 850 at a predetermined location in the HDD 202 of the PC 1 (S1405) to install the device management control file 800 or 850 (S1406). Upon completion of the installation, the device management 80 ends the device management control file installation processing (S1407). In this embodiment, assume that the device management control file 800 or 850 corresponding to the device (MFP 3) is detected and installed. If it is determined in step S1404 that the device management control file 800 or 850 is not found, the device management 80 ends the device management control file installation processing without installing the device management control file 800 or 850 (S1407).

<Launching Sequence of Device Management Screen>

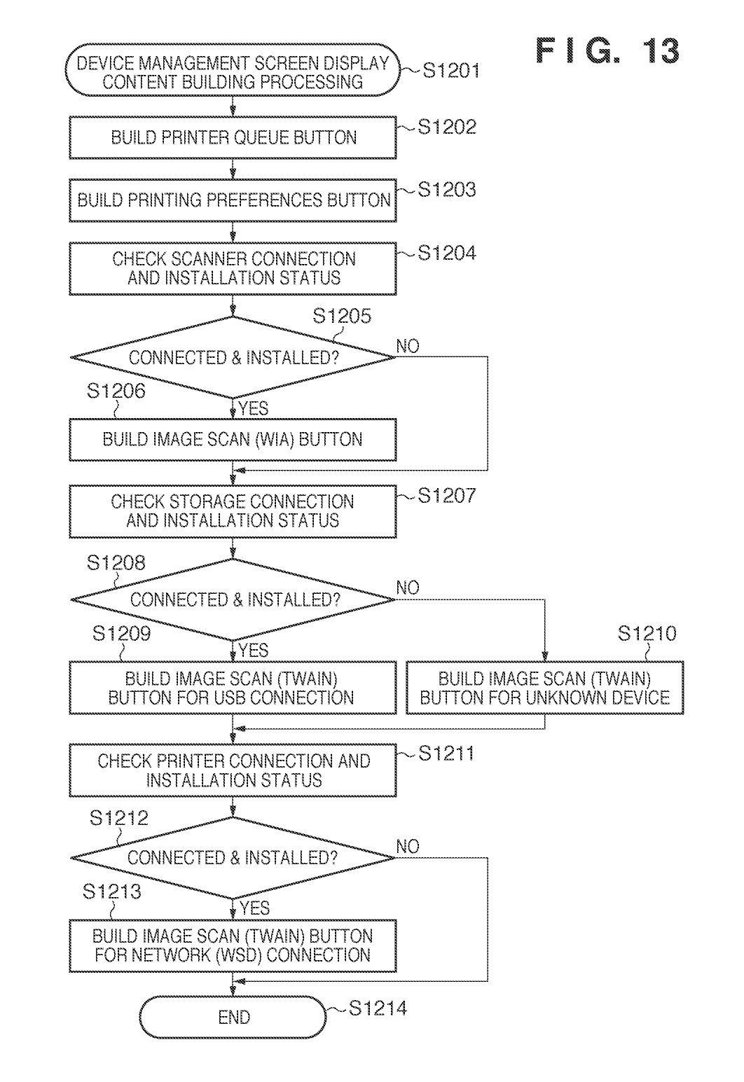

FIG. 12 is a flowchart showing the device management screen launching processing (S1308). A program related to the flowchart shown in FIG. 12 is stored in the HDD 202, is read out onto the RAM 201, and is executed by the CPU 204. This sequence is executed when the device management 80 executes the device management screen launching processing in step S1308 in FIG. 10 or when the user selects the device 503 in the [Devices and Printers] folder 500 and the device management 80 starts that processing (S401). The device management control module 902 acquires a device name selected in the [Devices and Printers] folder 500 (S402). In this embodiment, since the device 503 is selected, a device name “ABC Kmmn” is acquired. Based on this device name, the device management control file loading module 904 loads the device management control file 800 or 850 which is saved in step S1405 in FIG. 11 and is shown in FIG. 8 or 9 (S403). Based on this device management control file 800 or 850, the device management control module 902 executes device management screen display content building processing to be described later using FIG. 13 (S404). According to the display contents of the device management screen built in step S404, the device management control module 902 displays the device management screen 600 via the display module 901 (S405), and the device management 80 ends the device management screen launching processing (S406). As a result of this sequence, for example, the device management screen 600 shown in FIG. 5B is displayed.

<Building Sequence of Display Contents of Device Management Screen>

FIG. 13 is a flowchart showing the device management screen display content building processing (S404). A program related to the flowchart shown in FIG. 13 is stored in the HDD 202, is read out onto the RAM 201, and is executed by the CPU 204. When the device management screen display content building processing is executed in step S404 in FIG. 12, the device management control module 902 starts the device management screen display content building processing in FIG. 13 (S1201). The device management control module 902 builds the printer queue button 604 according to the contents of the <dm:name> element 805 and <dm:execute> element 806 in FIG. 8 or 9 (S1202). For example, a name described as the “name” element is laid out on the UI window screen at a position above or adjacent to an image object which represents the button. The contents of the “execute” element indicates a function or label to be execute when the user makes an execution operation (for example, clicking) for that button. In this example, the function (or program) indicated by “OpenPrinterQueue” is associated.

The device management control module 902 builds the printing preferences button 605 according to the contents of the <dm:name> element 807 and <dm:execute> element 808 in FIG. 8 or 9 (S1203). The device management control module 902 checks a scanner connection and installation status according to the contents of the <dm:device> element 811 and <dm:available> element 812 in FIG. 8 or 9 (S1204). When the MFP 3 is connected to the PC 1 via the USB interface 14, and the IHV WIA driver 704 available from the manufacturer (ABC company) is installed, or when the MFP 3 is connected to the PC 1 via the WSD network 4, and the OS-standard common WIA driver 703 is installed (S1205), the process advances to step S1206. If none of these conditions are satisfied (S1205), the process jumps to step S1207. In step S1206, the device management control module 902 builds the image scan (WIA) button 610 according to the contents of the <dm:name> element 809 and <dm:execute> element 813 in FIG. 8 or 9. Step S1206 represents a case in which an image can be scanned by the IHV WIA driver 704 or common WIA driver 703 via a USB or network (WSD) connection.

In step S1207, the device management control module 902 checks a storage function connection and installation status according to the contents of the <dm:device> element 815 and <dm:available> element 816 in FIG. 8 or 9. When the MFP 3 is connected to the PC 1 via the USB interface 14, and an OS-standard storage-class driver is installed (S1208), the process advances to step S1209. Otherwise (S1208), the process advances to step S1210. In step S1209, the device management control module 902 builds the image scan (TWAIN) button 611 for a USB connection according to the contents of the <dm:name> element 814 and <dm:execute> element 817 in FIG. 8 or 9. Step S1209 represents a case in which an image can be scanned by the TWAIN driver 141 via a USB connection. In step S1210, the device management control module 902 builds the image scan (TWAIN) button 611 for a USB connection according to the contents of the <dm:name> element 818 and <dm:execute> element 821 in FIG. 8 or 9. Step S1210 represents a case in which an image cannot be scanned by the TWAIN driver 141 via a USB connection and, for example, a case in which the PC 1 and MFP 3 are not connected via the USB interface 14 or network 4. In such case, the image scan (TWAIN) button 611 for an unknown device, which is used to launch the TWAIN application 142, is built.

The device management control module 902 checks a printer connection and installation status according to the contents of the <dm:device> element 823, <dm:available> element 824, and <dm:port> element 825 in FIG. 8 or 9 (S1211). When the MFP 3 is connected to the PC 1 via the WSD network 4, and the printer driver 50 is installed (S1212), the process advances to step S1213. Otherwise (S1212), the process jumps to step S1214 to end the device management screen display content building processing. In step S1213, the device management control module 902 builds the image scan (TWAIN) button 611 for a network (WSD) connection according to the contents of the <dm:name> element 822 and <dm:execute> element 826 in FIG. 8 or the <dm:name> element 827 and <dm:execute> element 831 in FIG. 9. Step S1213 represents a case in which an image can be scanned by the TWAIN driver 141 via a network (WSD) connection. After that, the process advances to step S1214 to end the building processing of the device management screen display contents (that is, display data on the device management screen).

Note that in the sequence shown in FIG. 13, connections and installation statuses are sequentially checked for respective functions of the MFP. However, as shown in, for example, FIG. 8, since respective functions are described as “function” elements, loop processing may be executed to have each “function” element as a unit. In this case, by referring to a parameter described in a “name” element in each “function” element, a device to be connected and a driver to be installed can be decided, thus allowing to check the connection of the decided device and the installation status of the decided driver. If both the conditions are satisfied, a button is built in the UI window. In this way, even when functions of the MFP other than those described in this example are available, the device management screen for these functions can be flexibly built.

<Launching of TWAIN Application>

FIG. 15 is a flowchart showing the TWAIN application launching processing. A program related to the flowchart shown in FIG. 15 is stored in the HDD 202, is read out onto the RAM 201, and is executed by the CPU 204. When the user presses the image scan (TWAIN) button 611 on the device management screen 600, the launching processing of the TWAIN application 142 is started in FIG. 15 (S1501).

Upon pressing of the button, the device management control module 902 in the device management 80 in FIG. 14 launches the TWAIN application 142, and passes a program name associated with the button 611 to the application control module 907 via the link execution module 903 in step S1501. In this example, the program name to be passed is, for example, that which is associated with the button 611 upon building of the screen 600 of the information described in the <dm:execute> element 817, 821, or 826 in FIG. 8. The application control module 907 acquires device designation information represented by the TWAIN driver name of the first argument from this information (S1502). This information will be especially referred to as a designated driver name or designated device name hereinafter.

When the application control module 907 checks the presence/absence of the TWAIN driver name of the first argument, that is, device designation information, and designation of a device (device designation information) is present (S1503), the process advances to step S1506. If designation of a device (device designation information) is absent in step S1503, the process advances to step S1504. Note that designation of a device is that of a driver itself in this case. In this embodiment and other embodiments, a device seen from software installed in the PC 1 is its device driver rather than hardware, and the device seen from software can be reworded as “driver”.

In this embodiment, since a device, that is, a driver is designated by the TWAIN driver name of the first argument described in the <dm:execute> element 817 or 826 in FIG. 8, the process advances from step S1503 to step S1506.

On the other hand, when the TWAIN application 142 is launched without setting the first argument, or when an unknown device is designated by the TWAIN driver name of the first argument described in the <dm:execute> element 821 in FIG. 8, the process advances from step S1503 to step S1504.

In step S1504, the default device setting module 908 loads a default device name (a scanner designated by the TWAIN driver name) which is stored in and managed by the default device information storage module 911 (more specifically, the registry of the OS), and the process advances to step S1505.

In step S1505, the loaded device name is set as a default device of the TWAIN application 142. That is, the default device name loaded in step S1504 is copied to a default device information area assured on the RAM. Note that the default device name copied to the RAM serves as information required to identify a peripheral device used by a function of an application to be executed. In this case, more specifically, a driver name of a corresponding device driver is used so as to use a peripheral device.

It is checked in step S1506 if the designated device (a scanner designated by the TWAIN driver name) is a network-connected device, and a device name (driver name) includes a MAC address. In case of a network-connected device without any MAC address ([example] “ABC Kmmn (TWAIN) WSD” or “ABC Kmmn (TWAIN) Network”), the process advances to step S1508. If the designated device is not a network-connected device ([example] “ABC Kmmn (TWAIN)”) or if the designated device is a network-connected device and has a MAC address ([example] “ABC Kmmn (TWAIN)_AABBCCXX0814”), the process advances to step S1507. A device which is not a network-connected device is that which is connected to the PC 1 via an interface other than the network. When the TWAIN application 142 controls a device (MFP) using an IHV unique protocol in place of the WSD protocol via the TWAIN driver 141 using that unique protocol, “ABC Kmmn (TWAIN) Network” above is designated as a network-connected device without any MAC address.

In step S1507, a device (driver) name of the designated device (the scanner designated by the TWAIN driver name) is set as a default device of the TWAIN application 142, that is, it is stored in the default device information storage module 911, and the process jumps to step S1514.

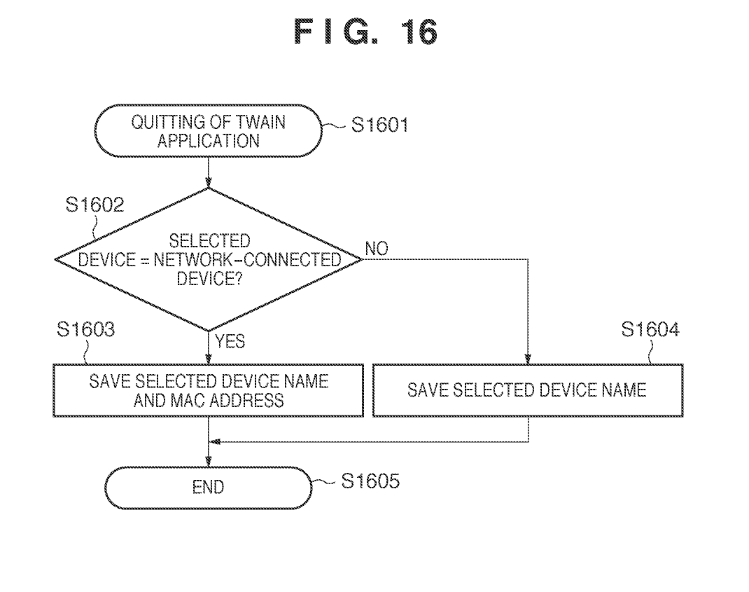

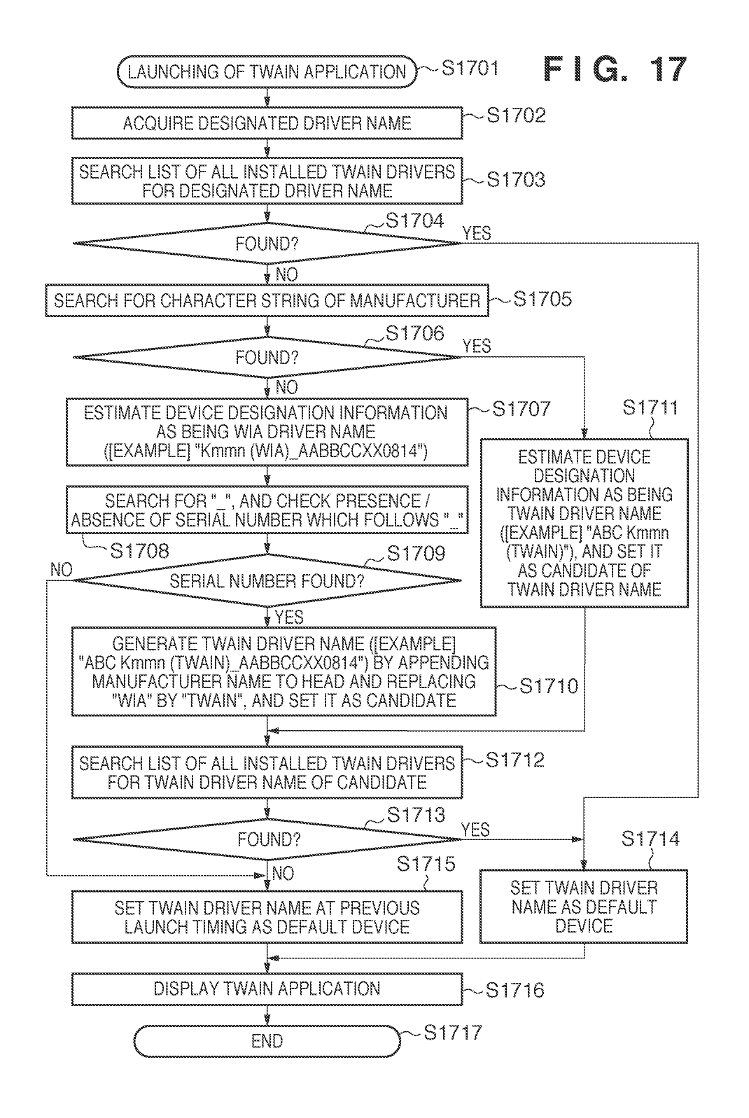

In step S1508, the default device setting module 908 acquires previously used MAC address information by referring to use history information stored in the default device information storage module 911 using the designated network-connected device name. In this case, the use history information is a use history stored in step S1603 in FIG. 16. More specifically, the default device setting module 908 searches the use history for a device name which matches the designated device name in step S1508.

If it is determined that the use history includes MAC address information of the designated network device (S1509), the process advances to step S1510. On the other hand, if the designated device name is not recorded in the use history or if it is recorded but no MAC address information is available, the process advances to step S1511.

In step S1510, the device (driver) name which is acquired from the use history information in step S1508 and includes the MAC address information of the previously used network device is set as a default device of the TWAIN application 142. The process then jumps to step S1514.

In step S1511, a network-connected device having the designated device name is searched on the network. If the device is found on the network (YES in step S1512), the process advances to step S1513, and the device name which is found first and its MAC address are set as a default device. The process then advances to step S1514.

If no device is found on the network, the process returns to step S1504.

In step S1514, the application control module 907 executes the TWAIN application 142 to display a UI, thus ending the TWAIN application launching processing (S1515). A program to be executed in this case is, for example, a sub-module in the TWAIN application, which corresponds to the function (that is, the program name) associated with the pressed button. In this manner, the designated function is implemented.

At this time, the TWAIN application 142 is launched and displayed while the default device set in step S1505, S1510, or S1513 is selected. Note that the default device information of the TWAIN application 142 is stored in a memory on the RAM 201 managed by the TWAIN application 142. Note that the default device name held in the RAM is cleared as soon as the TWAIN application 142 is quitted. However, this default device name may be written back to the registry as a new default device.

Strictly speaking, the default device saved in the RAM is a device which is set as a default device only when it is registered as a default device in the registry. That is, the sequence in FIG. 15 can be that for deciding the selected device (that is, the selected driver). The same applies to FIGS. 17, 18, and 22.

With the above sequence, upon launching of the TWAIN application 142, a new default device is decided using the device name designated by the parameter at the launch timing in preference to a default device saved in advance in the registry. That is, when one device can be specified based on the parameter at the launch timing, that device is set as a new default device. Even when one device to be used cannot be specified based on the parameter at the launch timing, if candidates can be narrowed down, a corresponding device is detected by a search from the candidates with reference to the previous use history if it is available. Or if such use history is not available, a corresponding device is detected by a search from connected devices. Then, a new default device is set. When no device is designated in the parameter at the launch timing, or when a designated device is not connected, a default device saved in the registry is used intact.

<Quitting of TWAIN Application>

FIG. 16 is a flowchart showing the TWAIN application quitting processing. In step S1601, the user instructs to quit the TWAIN application 142. Then, the sequence shown in FIG. 16 is executed.

It is checked in step S1602 if the selected device name is that of a network-connected device. If the selected device name is that of a network-connected device, the process advances to step S1603. On the other hand, if the selected device name is not that of a network-connected device, the process advances to step S1604. In step S1603, the MAC address of the device is saved in the default device information storage module 911 (more specifically, the registry of the OS) together with the selected device name. This step is executed by the default device setting module 908 of the TWAIN application 142. In step S1604, the selected device name is saved in the default device information storage module 911 (more specifically, the registry of the OS). In step S1605, the TWAIN application is quitted. This step is also executed by the default device setting module 908 of the TWAIN application 142.

As described above, upon quitting of the TWAIN application, the name of the device selected as that to be used at that time is saved as information indicating a previously selected device name, that is, a use history of the device. When a network-connected TWAIN device is selected, the MAC address of the network interface of that device is saved as the use history together. The saved device name and MAC address are referred to for device designation when a device is designated but it cannot be perfectly specified as well as its address at the next launch timing of the TWAIN application 142.

Note that the use history for one generation may be recorded. Alternatively, use histories for a plurality of generations may be recorded. When use histories for two generations are to be recorded, device names and MAC addresses of the latest use device and previously used device (to be also simply referred to as a use history hereinafter) are recorded. Upon recording use histories for a plurality of generations, since the oldest use history is overwritten by the latest use history, at least information used to specify the oldest use history is appended. This information may be, for example, a recording date and time. Or when a ring-like data structure defined by logically connecting the start and end of a recording area is adopted, that information may be, for example, a mark indicating the next recording area. By recording use histories for a plurality of generations, for example, even when a plurality of MFPs are selectively used, the use histories of the respective MFPs can be easily recorded. The same applies to a case in which there are a plurality of users of the PC 1, and use histories for the respective users can be easily recorded. Since only the default device in the RAM is updated without updating that in the registry, when the TWAIN application 142 is launched from a position other than the device management screen 600, the originally set default device can be easily used.

Note that in place of preparing for a decided area as a use history, a device name may be saved as a default device of the registry in step S1603 or S1604. In this case, even in the sequence of FIG. 15, in a step which refers to the use history, the default device saved in the registry is referred to in place of the use history. Then, the need for the use history saving area can be obviated. Also, the default device of the registry is updated every time the TWAIN application 142 is launched from the device management screen 600 and is quitted.

### Effect of This Embodiment

As described above, according to this embodiment, a new default device is decided using a device name designated by the parameter at the launch timing of the TWAIN application in preference to the default device at that time. That is, when one device can be specified based on the parameter at the launch timing, that device is set as a default device. Even when one device to be used cannot be specified based on the parameter at the launch timing, if candidates can be narrowed down, a corresponding device is detected by a search from the candidates with reference to the previous use record (history) if it is available. Or if such use record is not available, a corresponding device is detected by a search from connected devices. Then, a default device is set. When no device is designated in the parameter at the launch timing, or when a designated device is not connected, a current default device (that is, a device before the re-setting) is used intact. In this manner, when an application program associated with a device is launched, the device which originally serves as a source for tracing the application is used as a default of that application.

For this reason, at the time of execution of an application, a device selected on Device Stage is preferentially used as a default device.

### Second Embodiment

This embodiment uses FIG. 17 in place of FIG. 15 and FIG. 9 in place of FIG. 8, but other arrangements are the same as those in the first embodiment.

FIG. 9 shows the contents of a device management control file 850. FIG. 9 is one of views which best illustrate the characteristic features of the present invention. The device management control file 850 is that for English. Information shown in FIG. 9 is stored in a file storage unit 11 or 12. In FIG. 9, the same reference numerals denote the same contents as those which have already been described using FIG. 8, and a description thereof will not be repeated. In FIG. 9, pieces of information set in a <dm:manufacturer> element 801 and <dm:model> element 802 are used at the time of installation of the device management control file 850. Also, the device management control file 850 describes information required to configure a device management screen 600. In order to display a printer queue button 604, printing preferences button 605, image scan (WIA) button 610, and image scan (TWAIN) button 611 shown in FIG. 5B on the device management screen 600 which is launched and displayed when an MFP 3 is connected to a PC 1, <dm:function> elements 804, 839, 840, 841, 842, and 844 which represent the respective buttons and functions are set in a <dm:functions> element 853.

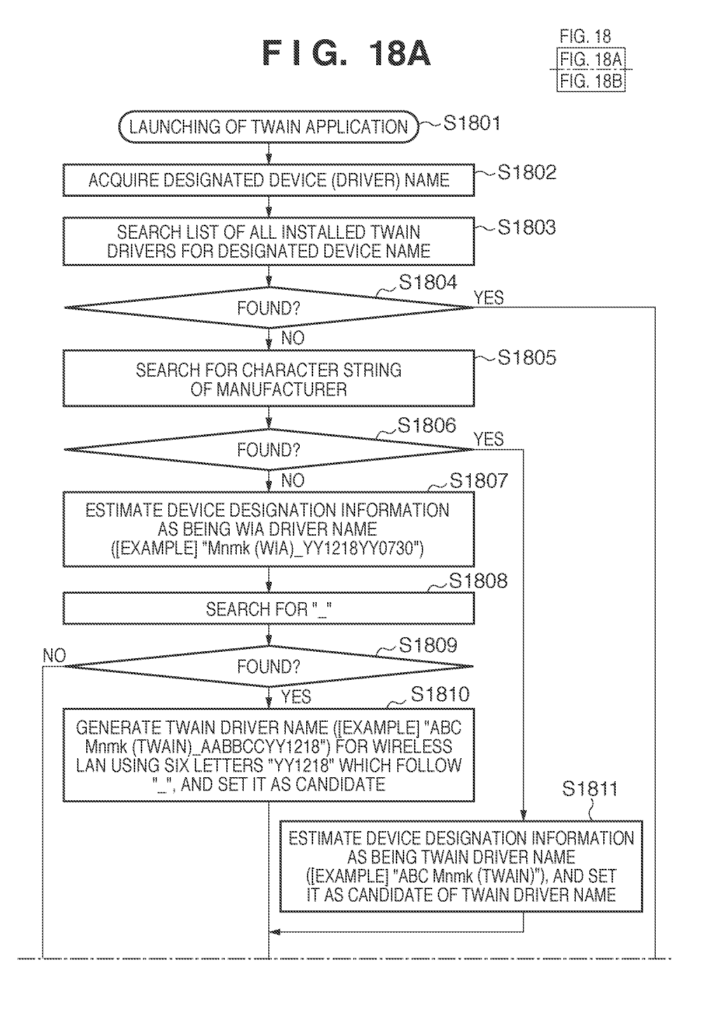

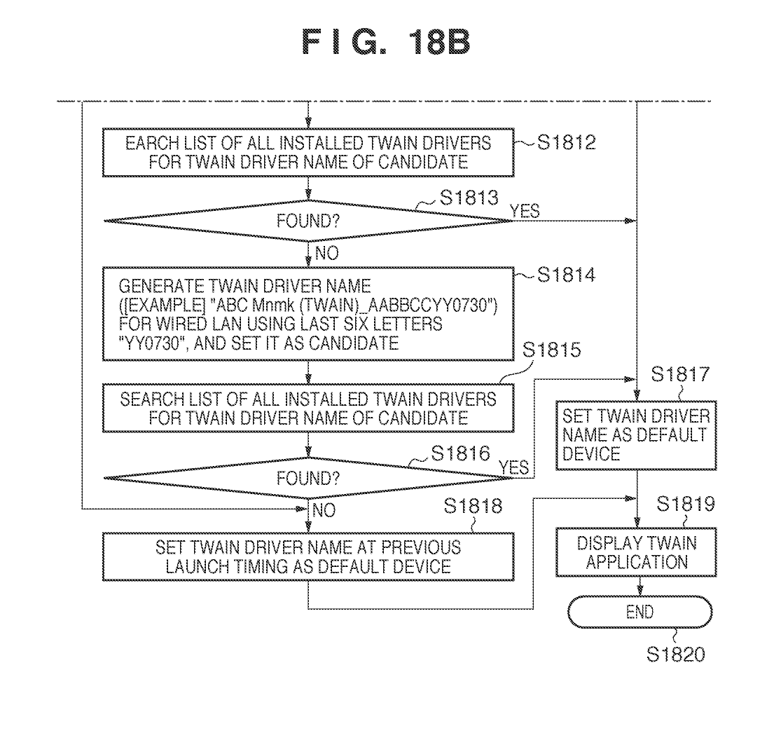

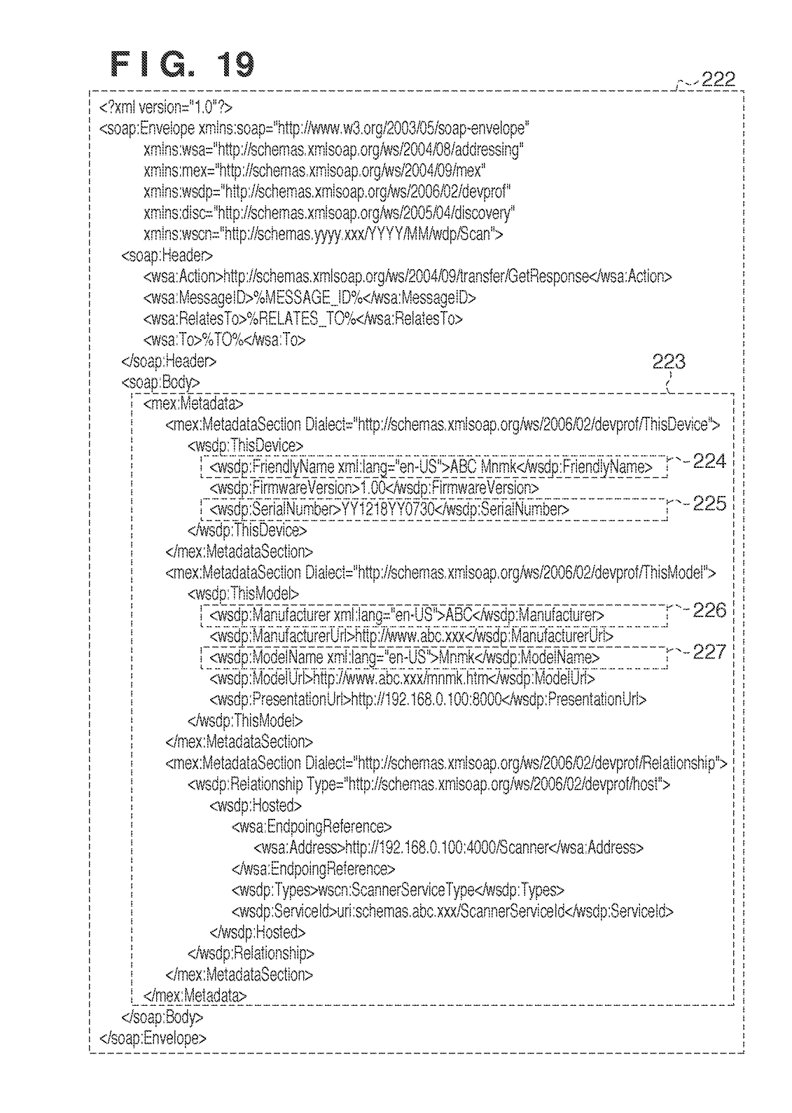

In the <dm:function> element 844, a character string “Image Scan (TWAIN)” displayed on the image scan (TWAIN) button 611 is set in a <dm:name xml:lang=“en-US”>Image Scan (TWAIN)</dm:name> element 827. In a <dm:required> element 848, information indicating conditions required to display the image scan (TWAIN) button 611 is set. A <dm:device>printer</dm:device> element 828 represents that a device connected to the PC 1 includes a printer function. A <dm:available>true</dm:available> element 829 represents that the printer function of the device connected to the PC 1 is available. A <dm:port>WSD</dm:port> element 830 represents that a port required to use the printer function of the device is a WSD port. In this case, the WSD port is a WSD network-connection port. Note that the <dm:port>WSD</dm:port> element 830 is defined as an OS standard function. It is a common practice to use a <dm:required> element 810 to discriminate whether or not a scanner function of the device (MFP 3) connected to the PC 1 is available. However, the Windows 7 OS cannot execute automatic switching control which discriminates a USB connection and WSD network connection and executes appropriate control according to the discriminated connection in the scanner function using a TWAIN driver 141, when the <dm:required> element 810 is used. Therefore, in the <dm:required> element 810, appropriate values which match respective interfaces according to the interfaces of the PC 1 and MFP 3 cannot be set as an argument upon launching a TWAIN application 142. Hence, the scanner function is discriminated by specifying an interface between the PC 1 and device (MFP 3) using a “state in which the printer function is available” as another function which is not related to the scanner function and “port name of the printer function”, as represented by the <dm:required> element 848. Then, appropriate information is set as an argument upon launching the TWAIN application 142, thus improving the user's operability. In this way, the conditions represented by the <dm:required> element 848 correspond to a case in which an image can be scanned by the TWAIN driver via a WSD network connection. In a <dm:execute>TWAINScan.exe “WIAScannerName” /devmng</dm:execute> element 831, a code [TWAINScan.exe “WIAScannerName”/devmng] which represents a function (program) required to launch the TWAIN application 142 is set. As described above, “WIAScannerName” is a variable which represents a WIA driver name assigned to the MFP 3, and is information which is not related to the TWAIN application 142. This embodiment can assure high user's operability, since the TWAIN application 142 can be launched in a state in which it automatically generates a TWAIN driver name dedicated to a device selected on the device management screen 600, and an optimal TWAIN driver dedicated to that device is selected, as shown in FIGS. 17 and 18. Note that a name named as a device name in the first embodiment corresponds to a driver name in this embodiment. Hence, the driver name will also be referred to as a device name in correspondence with the first embodiment.

FIG. 17 is a flowchart showing TWAIN application launching processing. FIG. 17 is one of views which best illustrate the characteristic features of this embodiment. A program related to the flowchart shown in FIG. 17 is stored in an HDD 202, is read out onto a RAM 201, and is executed by a CPU 204. FIG. 17 shows an example in which the TWAIN application 142 assumes the MFP 3 and an MFP 777. When the user presses the image scan (TWAIN) button 611 on the device management screen 600, the launching processing of the TWAIN application 142 is started in FIG. 17 (S1701).

In step S1701, a device management control module 902 in a device management 80 in FIG. 14 launches the TWAIN application 142, and passes information described in a <dm:execute> element 817, 821, or 831 in FIG. 9 to an application control module 907 via a link execution module 903. The application control module 907 acquires device designation information represented by a TWAIN driver name or WIA driver name of a first argument from the information described in the <dm:execute> element 817, 821, or 831 (S1702). The application control module 907 searches, based on the TWAIN driver name or WIA driver name of the first argument, that is, the device designation information, a list of all TWAIN drivers (TWAIN data sources (to be also abbreviated as TWAIN DS hereinafter)) installed in the PC 1 for the device designation information (S1703). The list of all the TWAIN drivers installed in the PC 1 is stored in, for example, a registry managed by the OS. If the application control module 907 finds the device designation information in the TWAIN driver (TWAIN DS) list, the process jumps to step S1714; otherwise, the process advances to step S1705 (S1704). In step S1705, the application control module 907 searches the device management information for a character string (for example, “ABC”) which represents the manufacturer. As this character string, one which is obtained from a manufacturer element in, for example, device management information (FIG. 8), can be used. If the application control module 907 finds this character string, the process jumps to step S1711; otherwise, the process advances to step S1707 (S1706). In step S1707, the application control module 907 estimates that the device designation information is a WIA driver name ([example] “Kmmn (WIA)_AABBCCXX0814”). Note that step S1707 is a pseudo step which indicates a thought process of programming, and nothing is executed in step S1707 in actual computer processing. Hence, if the application control module 907 searches the device designation information for “_” and finds it, it checks the presence/absence of a serial number which follows “_” (S1708).

If the application control module 907 determines that a serial number follows, the process advances to step S1710; otherwise, the process jumps to step S1715 (S1709). In step S1710, the application control module 907 appends a character string (for example, “ABC”) of a manufacturer name to the head of the device designation information, and replaces a character string “WIA” by “TWAIN” to generate a TWAIN driver name ([example] “ABC Kmmn (TWAIN)_AABBCCXX0814”). As the manufacturer name to be added, that described in a manufacturer name element of the device management information shown in, for example, FIG. 8 can be used. Then, the generated TWAIN driver name is set as a TWAIN driver name candidate. “Set” in this case is to temporarily save the driver name candidate in a predetermined storage area. In step S1711, the application control module 907 estimates that the device designation information is a TWAIN driver name ([example] “ABC Kmmn (TWAIN)”), and sets it as a TWAIN driver name candidate.

In step S1712, the application control module 907 searches the list of all the TWAIN drivers (TWAIN DS) installed in the PC 1 for the TWAIN driver name set as the candidate in step S1710 or S1711. If the application control module 907 finds the TWAIN driver name as the candidate in the TWAIN driver (TWAIN DS) list, the process advances to step S1714; otherwise, the process advances to step S1715 (S1713). In step S1714, a default device setting module 908 sets the TWAIN driver name as the candidate as a default device, and the process advances to step S1716.

In step S1715, the default device setting module 908 acquires a device name saved in the registry, that is, a device name (a scanner designated by a TWAIN driver name) stored in a default device information storage module 911 (more specifically, the registry of the OS). This device name is saved in step S1603 or S1604 in FIG. 16. Therefore, when the device name is saved in a use history of the registry in these steps, the device name is acquired from there; when it is set as a default device in the registry, the device name is acquired from there. The acquired TWAIN driver name is set as a default device, and the process advances to step S1716. “Set” in this case is to save the device name in, for example, a predetermined area assured for a default device on the RAM. In step S1716, the application control module 907 displays a main dialog of the TWAIN application 142 shown in FIG. 6B, thus ending the TWAIN application launching processing (S1717). At this time, the TWAIN application 142 is launched and displayed while the default device set in step S1714 or S1715 is selected. Note that information of the default device of the TWAIN application 142 is held in a memory on the RAM 201 managed by the TWAIN application 142. Note that the TWAIN application 142 executes the same processing as the TWAIN application quitting processing shown in FIG. 16 when it is quitted. In this case, in step S1603, a serial number (AABBCCXX0814) is saved in place of a MAC address.

With the aforementioned sequence, when the TWAIN application is launched from the device management screen 600, a device associated with launching (that is, a selected device) can be preferentially used as a default device. When a device which matches the selected device name is not connected, a device name of a TWAIN device which includes all or one of a manufacturer name, model name, and serial number included in the selected device name is generated to search for a corresponding device. If such device is found, it is set as a default device. In this manner, the selected device can be preferentially used.

### Modification of Second Embodiment

A modification of the second embodiment will be described below. In this modification, the TWAIN application launching sequence is replaced by that shown in FIG. 18.

In the example of FIG. 17, the application control module 907 checks in step S1713 whether or not the TWAIN driver name candidate perfectly matches that in the TWAIN driver (TWAIN DS) list upon conducting the search. However, the present invention is not limited to this example. For example, in case of a network device, when that device is displayed on the PC as that on a network, the user can change a friendly name that represents the device in some cases. In such case, the user is allowed to change the friendly name to include a serial number portion by necessity, thus allowing to apply the present invention. In this case, even when the TWAIN driver name does not perfectly match that in the TWAIN driver (TWAIN DS) list in step S1713, if a TWAIN driver whose serial number matches is found, the process advances to step S1714. Then, in step S1714 the default device setting module 908 sets the TWAIN driver name whose serial number matches as a default device. Hence, a peripheral device control system with high operability, which can apply the present invention to obtain the same effect even when the user changes the friendly name, can be implemented.

The aforementioned embodiment has exemplified the case in which the TWAIN driver name and WIA driver name include a serial number. However, the present invention is not limited to this example. For example, an IP address (Internet Protocol Address) may be used. Now assume that a WIA driver name is “Defg (WIA), 192.168.0.88” and a TWAIN driver name is a “XYZ Defg (TWAIN), 192.168.0.88”. The following description will be given by applying these driver names to the flowchart shown in FIG. 17. In step S1705, the application control module 907 searches the device designation information for a character string “XYZ” which represents a manufacturer. If the application control module 907 finds this character string, the process jumps to step S1711; otherwise, the process advances to step S1707 (S1706). In step S1707, the application control module 907 estimates that the device designation information is a WIA driver name ([example] “Defg (WIA), 192.168.0.88”). If the application control module 907 searches the device designation information for “,”, and finds it, it confirms the presence/absence of an IP address that follows “,” (S1708). If the application control module 907 determines that an IP address follows, the process advances to step S1710; otherwise, the process jumps to step S1715 (S1709). In step S1710, the application control module 907 appends “XYZ” to the head of the device designation information and replaces “WIA” by “TWAIN” to generate a TWAIN driver name “XYZ Defg (TWAIN), 192.168.0.88”, and sets it as a TWAIN driver name candidate. In step S1711, the application control module 907 estimates that the device designation information is a TWAIN driver name “XYZ Defg (TWAIN)”, and sets it as a TWAIN driver name candidate. In this way, even when information used to specify a device is an IP address, the TWAIN application 142 can be launched while an optimal TWAIN driver that specifies an individual of a device displayed on the device management screen 600 is selected, thus assuring high user's operability.

### Third Embodiment

The third embodiment will be described below. The third embodiment is implemented by a system having the same arrangement as that of the first embodiment. However, the TWAIN application launching sequence is replaced by that shown in FIG. 18. In the third embodiment, the example of the second embodiment is modified to be applied to a system which includes both wireless and wired LANs, and includes devices connected to a network via both the LANs. Now assuming a case of a device such as an MFP 888, which supports network interfaces of both a wireless LAN (IEEE802.11b/g/n) and wired LAN (Ethernet). As has been described previously using FIG. 1, a serial number of the MFP 888 is expressed by a value “YY1218YY0730” by combining lower 24 bits of a MAC address “AABBCCYY1218” as a wireless LAN device and those of a MAC address “AABBCCYY0730” as a wired LAN device.

FIG. 19 shows WSD-based N-PnP information issued from the MFP 888. Referring to FIG. 19, a SOAP (Simple Object Access Protocol) message 222 is sent from the MFP 888 to a PC (PC 1) at the time of network plug and play (N-PnP) processing. A SOAP metadata (<mex:Metadata>) element 223 includes detailed information of the MFP 888. A WSD friendly name (<wsdp:FriendlyName>) element 224 is set with a WSD friendly name of the MFP 888. In this case, the element 224 represents an example in which a friendly name “ABC Mnmk” is set. A WSD serial number (<wsdp:SerialNumber>) element 225 is set with a WSD serial number of the MFP 888. In this case, the element 225 represents an example in which a serial number “YY1218YY0730” of the MFP 888 is set. A WSD manufacturer name (<wsdp:Manufacturer>) element 226 is set with a WSD manufacturer name of the MFP 888. In this case, the element 226 represents an example in which a manufacturer name “ABC” of an ABC company as the manufacturer of the MFP 888 is set. A WSD model name (<wsdp:ModelName>) element 227 is set with a WSD model name of the MFP 888. In this case, the element 227 represents an example in which the aforementioned model name “Mnmk” of the MFP 888 is set.

FIG. 18 is a flowchart showing TWAIN application launching processing. FIG. 18 is one of views which best illustrate the characteristic features of the present invention. A program related to the flowchart shown in FIG. 18 is stored in an HDD 202, is read out onto a RAM 201, and is executed by a CPU 204. FIG. 18 represents an example in which an application 142 assumes the MFP 888. When the user presses an image scan (TWAIN) button 611 on a device management screen 600, the launching processing of the TWAIN application 142 is started in FIG. 18 (S1801). In step S1801, a device management control module 902 in a device management 80 in FIG. 14 passes information described in a <dm:execute> element 817, 821, or 831 in FIG. 9 to an application control module 907 via a link execution module 903. In this case, since the MFP 888 is assumed, “ABC Kmmn (TWAIN)” is replaced by “ABC Mnmk (TWAIN)” in the contents of the <dm:execute> element 817 or 831 in FIG. 9. From the information described in the <dm:execute> element 817, 821, or 831, the application control module 907 acquires device designation information represented by a TWAIN driver name or WIA driver name of a first argument (S1802). The application control module 907 searches, based on the TWAIN driver name or WIA driver name of the first argument, that is, the device designation information, a list of all TWAIN drivers (TWAIN data sources (to be also abbreviated as TWAIN DS hereinafter)) installed in the PC 1 for the device designation information (S1803). If the application control module 907 finds the device designation information in the TWAIN driver (TWAIN DS) list, the process jumps to step S1817; otherwise, the process advances to step S1805 (S1804).

In step S1805, the application control module 907 searches the device management information for a character string (for example, “ABC”) which represents the manufacturer. If the application control module 907 finds this character string, the process jumps to step S1811; otherwise, the process advances to step S1807 (S1806). In step S1807, the application control module 907 estimates that the device designation information is a WIA driver name ([example] “Mnmk (WIA)_YY1218YY0730”). Note that step S1807 is a pseudo step on programming, and nothing is executed in computer processing. Hence, if the application control module 907 searches the device designation information for “_” (S1808). If the application control module 907 finds “_”, the process advances to step S1810; otherwise, the process jumps to step S1818 (S1809). In step S1810, the application control module 907 appends a character string “ABC” of the manufacturer name to the head of the device designation information, and replaces “WIA” that represents a device type by “TWAIN”. Furthermore, the application control module 907 synthesizes a serial number “AABBCCYY1218” by joining upper 24-bit manufacturer information ([example] “AABBCC” assigned to the ABC company) of the MAC address assigned to the manufacturer and six letters ([example] “YY1218”) which follow “_” of the device designation information. Using these character strings, the application control module 907 generates a wireless LAN TWAIN driver name ([example] “ABC Mnmk (TWAIN)_AABBCCYY1218”), and sets, that is, saves it as a TWAIN driver name candidate.

In step S1811, the application control module 907 estimates that the device designation information is a TWAIN driver name ([example] “ABC Mnmk (TWAIN)”), and sets it as a TWAIN driver name candidate. Note in this step as well, “estimate” means nothing to be executed in computer processing. That is, in step S1811, the device name of the device designation information is saved as a TWAIN driver name candidate. In step S1812, the application control module 907 searches the list of all the TWAIN drivers (TWAIN DS) installed in the PC 1 for the TWAIN driver name saved as the candidate in step S1810 or S1811. If the application control module 907 finds the TWAIN driver name as the candidate in the TWAIN driver (TWAIN DS) list, the process jumps to step S1817; otherwise, the process advances to step S1814 (S1813).

In step S1814, the application control module 907 appends the character string “ABC” of the manufacturer name to the head of the device designation information, and replaces “WIA” as a device type by “TWAIN”. Furthermore, the application control module 907 synthesizes a serial number (“AABBCCYY0730”) by joining the upper 24-bit manufacturer information ([example] “AABBCC” assigned to the ABC company) of the MAC address assigned to the manufacturer and last six letters ([example] “YY0730”) of the device designation information. Then, using these character strings, the application control module 907 generates a wired LAN TWAIN driver name ([example] “ABC Mnmk (TWAIN)_AABBCCYY0730”), and sets, that is, saves it as a TWAIN driver name candidate. The application control module 907 searches the list of all the TWAIN drivers (TWAIN DS) installed in the PC 1 for the TWAIN driver name saved as the candidate in step S1814 (S1815). If the application control module 907 finds the TWAIN driver name as the candidate in the TWAIN driver (TWAIN DS) list, the process advances to step S1817; otherwise, the process advances to step S1818 (S1816).

In step S1817, a default device setting module 908 sets the TWAIN driver name as the candidate as a default device in a default device area assured on the RAM, and the process advances to step S1819. In step S1818, the default device setting module 908 acquires a device name saved in a registry, that is, a device name (a scanner designated by a TWAIN driver name) stored in a default device information storage module 911 (more specifically, the registry of the OS), and sets that TWAIN driver name as a default device. The process then advances to step S1819. This is the same as in step S1715 of FIG. 17. In step S1819, the application control module 907 displays a main dialog of the TWAIN application 142 shown in FIG. 6B, thus ending the TWAIN application launching processing (S1820). At this time, the TWAIN application 142 is launched and displayed while the default device set in step S1817 or S1818 is selected. Note that information of the default device of the TWAIN application 142 is held in a memory on the RAM 201 managed by the TWAIN application 142. Note that the TWAIN application 142 executes the same processing as the TWAIN application quitting processing shown in FIG. 16 when it is quitted. In this case, in step S1603, partial information (AABBCCYY1218) of the wireless LAN TWAIN driver name or partial information (AABBCCYY0730) of the wired LAN TWAIN driver name is saved in place of a MAC address.

As has been described above using FIGS. 17 and 18, the device management control module 902 in the device management 80 passes device designation information expressed by a WIA driver name to the application control module 907 via the link execution module 903. Then, the application control module 907 in the TWAIN application 142 generates a TWAIN driver name from the WIA driver name passed as the device designation information, the default device setting module 908 sets this TWAIN driver name as a default device, and the TWAIN application 142 is launched while this default device is selected. In this way, the TWAIN applicator 142 can be launched while an optimal TWAIN driver which specifies an individual of a device displayed on the device management screen 600 is selected, thus assuring high user's operability.

In step S1715 in FIG. 17 or step S1818 in FIG. 18, the default device setting module 908 sets a TWAIN driver name selected at the previous launch timing as a default device. However, the present invention is not limited to this example. For example, when the device management control module 902 in the device management 80 in FIG. 14 passes information “ABC Kmmn (TWAIN) WSD” described in a <dm:execute> element 826 in FIG. 8 to the application control module 907 via the link execution module 903, the process reaches step S1715 or S1818. In this case, the process advances to step S1502 in FIG. 15, and the application control module 907 or default device setting module 908 executes the processing shown in FIG. 15. Hence, the TWAIN application 142 can be launched while an appropriate TWAIN driver is selected, thus assuring high user's operability. As another example of a selection method, a priority order may be set in the order of, for example, a USB connection and network connection to narrow down search targets based on a model name of a device. Then, communication tests may be conducted for MFPs connected to the PC 1 in respective connection modes, and a TWAIN driver for a device having a high priority order, which is found first, may be selected. Furthermore, this method may be combined with a case which reaches step S1504 in the example of executing step S1502 in FIG. 15. According to these methods, a device which is available in an operable state can be surely selected, and the TWAIN application 142 can be launched while a more optimal TWAIN driver is selected, thus assuring high user's operability.

### Fourth Embodiment

Now, a case will be examined below wherein a plurality of devices (for example, MFPs 3 and 777) which are the same model but are different individuals are connected to a single PC (PC 1) via a USB interface 14 or network 4. In such case, it is often troublesome for the user who always operates a specific device from a TWAIN application 142 to make an operation for selecting a TWAIN driver using a scanner selection field 621. There is an example which improves the operability for such user by preparing for a scanner setting tool such as a scanner selector.

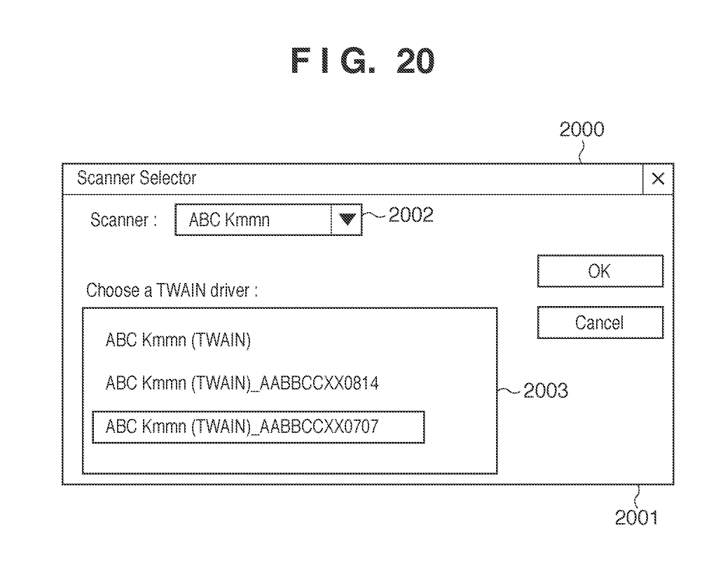

FIG. 20 shows a UI of a scanner selector. Referring to FIG. 20, a scanner selector 2000 is an application program available from an ABC company. The scanner selector 2000 is a scanner setting tool used to set in advance a TWAIN driver for a device to be operated by the TWAIN application 142 when a plurality of devices (for example, MFPs 3 and 777), which are the same model but are different individuals, are connected to the single PC (PC 1) via the USB interface 14 or network 4. A user interface 2001 is a main dialog of the scanner selector. A scanner selection field 2002 allows the user to select devices having scanner functions installed in the PC 1. In this case, assume that the user can select an MFP which has a model name “Kmmn” available from the ABC company and an MFP which has a model name available from the ABC company “Mnmk” from:

ABC Kmmn

ABC Mnmk

FIG. 20 shows a state in which “ABC Kmmn” that represents the MFP having the model name “Kmmn” available from the ABC company is selected. A TWAIN driver selection field 2003 lists up all TWAIN drivers for the device selected in the scanner selection field 2002, and allows the user to select one of these drivers. In FIG. 20, “ABC Kmmn (TWAIN)” is a TWAIN driver name for the MFP 3, which is connected to the PC 1 via the USB interface 14. “ABC Kmmn (TWAIN)_AABBCCXX0814” is a TWAIN driver name for the MFP 3, which is connected to the PC 1 via the network 4. “ABC Kmmn (TWAIN)_AABBCCXX0707” is a TWAIN driver name for the MFP 777, which is connected to the PC 1 via the network 4. FIG. 20 shows a state in which “ABC Kmmn (TWAIN)_AABBCCXX0707” is selected. In the fourth embodiment, as for TWAIN drivers listed up on the TWAIN driver selection field 2003, there is no TWAIN DS for each TWAIN driver, but they are merely displayed only within the TWAIN driver selection field 2003. Instead, as a TWAIN DS used when the scanner selector 2000, that having a name “ABC Kmmn Selector” is prepared. This TWAIN DS for the scanner selector 2000 is displayed as a choice of a TWAIN driver name “ABC Kmmn Selector” on the scanner selection field 621 on the main dialog of the TWAIN application 142. Therefore, in the fourth embodiment, on the scanner selection field 621, the user can select one of:

ABC Kmmn Selector

ABC Mnmk Selector

<Launching of TWAIN Application>

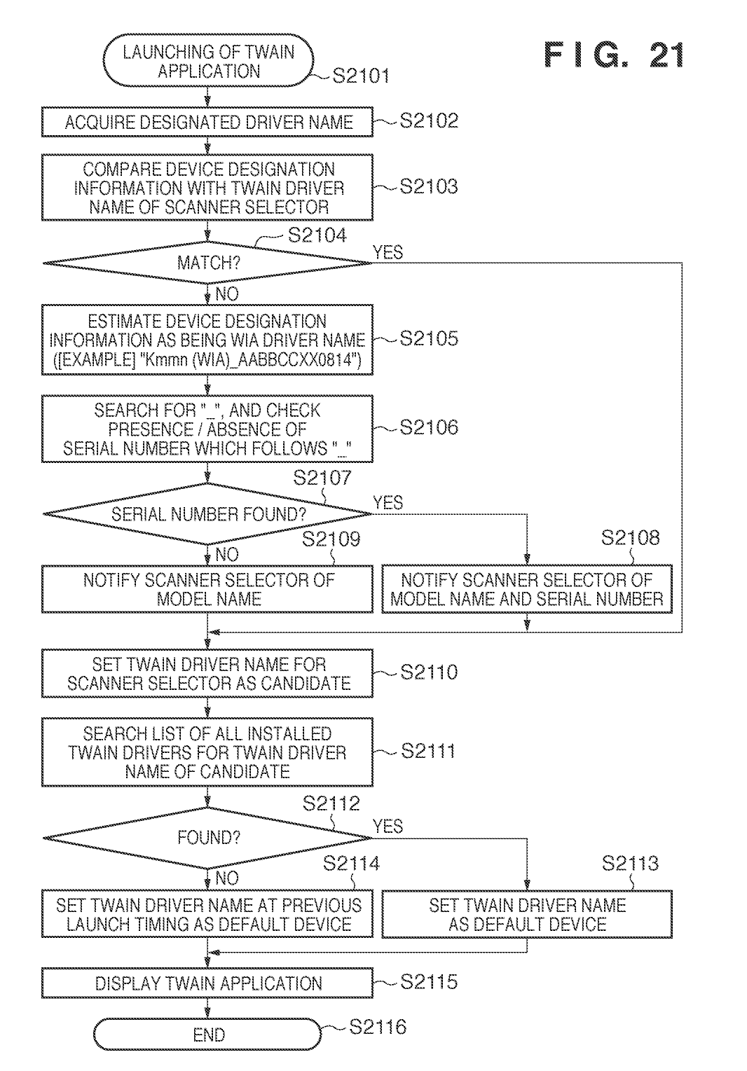

FIG. 21 is a flowchart showing the TWAIN application launching processing. FIG. 21 is one of views which best illustrate the characteristic features of the this embodiment. A program related to the flowchart shown in FIG. 21 is stored in an HDD 202, is read out onto a RAM 201, and is executed by a CPU 204. FIG. 21 shows an example in which the application 142 assumes the MFPs 3 and 777. When the user presses an image scan (TWAIN) button 611 on a device management screen 600, the launching processing of the TWAIN application 142 is started in FIG. 21 (S2101).

In step S2101, a device management control module 902 in a device management 80 in FIG. 14 passes information described in a <dm:execute> element 817, 821, or 831 in FIG. 9 to an application control module 907 via a link execution module 903. From the information described in the <dm:execute> element 817, 821, or 831, the application control module 907 acquires device designation information represented by a TWAIN driver name or WIA driver name of a first argument (S2102). The application control module 907 compares the TWAIN driver name or WIA driver name of the first argument, that is, the device designation information with is a TWAIN driver name “ABC **** Selector” for the scanner selector 2000 (S2103). If the application control module 907 determines that the device designation information is a TWAIN driver name for the scanner selector 2000, the process jumps to step S2110; otherwise, the process advances to step S2105.

In step S2105, the application control module 907 estimates that the device designation information is a WIA driver name ([example] “Kmmn (WIA)_AABBCCXX0814”). Note that nothing is executed in step S2105 except that a processing target is decided as the device designation information. Then, if the application control module 907 searches the device designation information for “_” and finds it, it checks the presence/absence of a serial number which follows “_” (S2106). If the application control module 907 finds the presence of a serial number, the process advances to step S2108; otherwise, the process advances to step S2109 (S2107).

In step S2108, the application control module 907 notifies the scanner selector 2000 of a model name ([example] “Kmmn”) and serial number ([example] “AABBCCXX0814”), and the process advances to step S2110. In step S2109, the application control module 907 notifies the scanner selector 2000 of a model name ([example] “Kmmn”), and the process advances to step S2110. In step S2110, the application control module 907 sets the TWAIN driver name for the scanner selector 2000 as a candidate. In step S2111, the application control module 907 searches a list of all TWAIN drivers (TWAIN DS) installed in the PC 1 for the TWAIN driver name set as the candidate in step S2110. If the application control module 907 finds the TWAIN driver name as the candidate in the TWAIN driver (TWAIN DS) list, the process advances to step S2113; otherwise, the process advances to step S2114 (S2112).

In step S2113, a default device setting module 908 sets the TWAIN driver name as the candidate as a default device, and the process advances to step S2115. In step S2114, the default device setting module 908 acquires a TWAIN driver name selected at the previous launch timing, that is, a device name (a scanner designated by a TWAIN driver name) stored in a default device information storage module 911 (more specifically, a registry of the OS), and sets that TWAIN driver name in the RAM as a default device. The process then advances to step S2115. In step S2115, the application control module 907 displays a main dialog of the TWAIN application 142 shown in FIG. 6B, thus ending the TWAIN application launching processing (S2116). At this time, the TWAIN application 142 is launched and displayed while the default device set in step S2113 or S2114 is selected. Note that information of the default device of the TWAIN application 142 is held in a memory on the RAM 201 managed by the TWAIN application 142. Note that the TWAIN application 142 executes the same processing as the TWAIN application quitting processing shown in FIG. 16 when it is quitted. In this case, when the TWAIN driver name for the scanner selector is set as the default device, the default device setting module 908 saves the TWAIN driver name for the scanner selector in step S1603 or S1604.

<Processing of Scanner Selector>

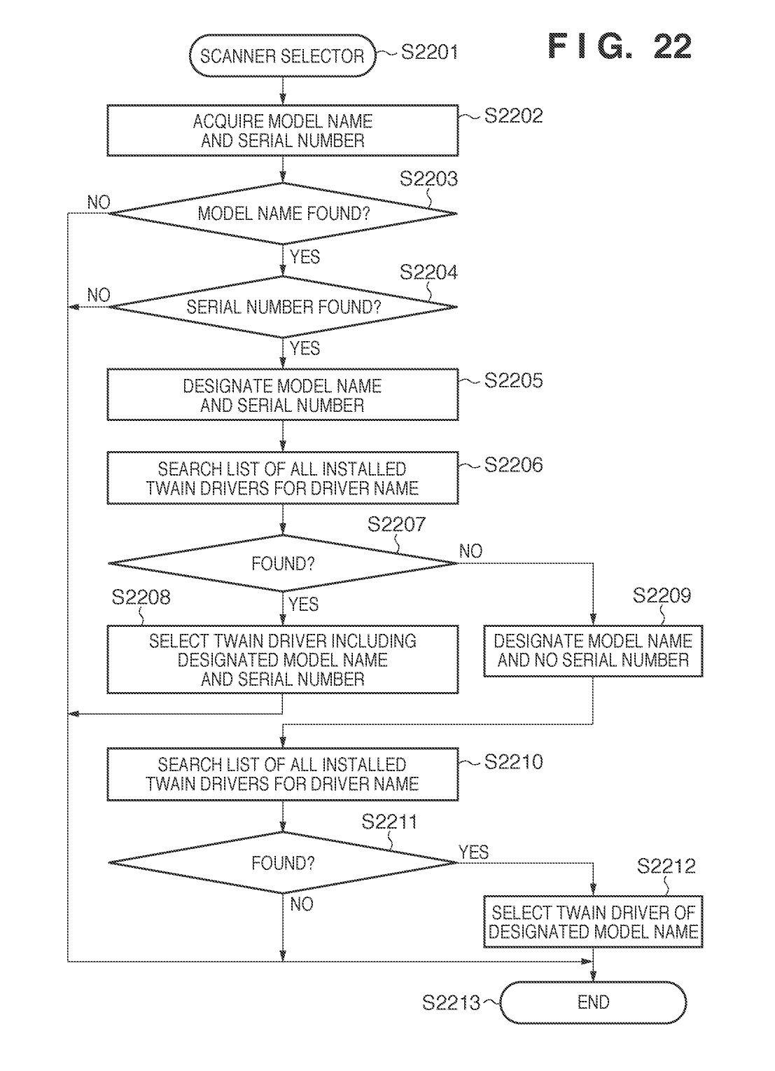

FIG. 22 is a flowchart showing the processing of the scanner selector. FIG. 22 is one of views which best illustrate the characteristic features of the present invention. A program related to the flowchart shown in FIG. 22 is stored in the HDD 202, is read out onto the RAM 201, and is executed by the CPU 204. When the application control module 907 executes step S2108 or S2109 in FIG. 21, the processing of the scanner selector 2000, which received the notification in the above step, is started in the sequence shown in FIG. 22 (S2201).

The scanner selector 2000 acquires a model name and a serial number, if it is notified, from the information notified from the application control module 907 (S2202). If the scanner selector 2000 finds the model name, the process advances to step S2204; otherwise, the process jumps to step S2213 (S2203). If the scanner selector 2000 finds the serial number in step S2204, the process advances to step S2205; otherwise, the process jumps to step S2213.

In step S2205, the scanner selector 2000 designates the acquired model name and serial number, and searches the list of all the TWAIN drivers installed in the PC 1 for a TWAIN driver name including the model name and serial number (S2206). If the scanner selector 2000 finds a TWAIN driver name including the model name and serial number in the TWAIN driver list, the process advances to step S2208; otherwise, the process advances to step S2209 (S2207). In step S2208, the scanner selector 2000 selects a device of the designated model name on the scanner selection field 2002, and selects a TWAIN driver including the designated model name and serial number on the TWAIN driver selection field 2003. Then, the process jumps to step S2213.

In step S2209, the scanner selector 2000 designates the model name and also that no serial number is included, and searches the list of all the TWAIN derivers installed in the PC 1 for a TWAIN driver name which includes the model name and does not include any serial number (S2210). If the scanner selector 2000 finds a TWAIN driver name which includes the model name and does not include any serial number in the TWAIN driver list, the process advances to step S2212; otherwise, the process advances to step S2213 (S2211). In step S2212, the scanner selector 2000 selects a device of the designated model name on the scanner selection field 2002, and selects a TWAIN driver which includes the designated model name and does not include any serial number on the TWAIN driver selection field 2003. Then, the process advances to step S2213. In step S2213, the scanner selector 2000 ends the processing for selecting a TWAIN driver based on the notified model name and serial number.

In step S2206 or S2210, all the TWAIN drivers installed in the PC 1 do not represent that a TWAIN DS for each TWAIN driver is installed, but they represent TWAIN drivers selectable on the TWAIN driver selection field 2003. Therefore, when, for example, one TWAIN driver is prepared for each model, and its serial number represents a communication port name, an embodiment which designates a TWAIN driver by a model name, and designates a communication port by a serial number is also included. The scanner selector 2000 saves information associated with a communication port represented by a serial number in the registry of the OS. A TWAIN driver acquires information associated with a communication port with reference to the registry when it is operated, and sends data to or receives if from that communication port, thereby controlling a device (scanner). Alternatively, the scanner selector 2000 may save information associated with a communication port in, for example, a file in place of the registry of the OS, and a TWAIN driver may acquire the information associated with the communication port with reference to that file.

As described above, even in the example using the scanner setting tool such as the scanner selector 2000, a peripheral device control system with high operability, in which the present invention can be applied to obtain the same effects, can be implemented.

### Fifth Embodiment

Functions which can be implemented by executing the flowcharts shown in FIGS. 10 to 13, FIGS. 15 to 18, FIG. 21, and FIG. 22 in the above embodiments may be implemented by the information processing apparatus based on externally installed programs. In this case, the present invention is applicable to even a case in which an information group including programs is supplied from a storage medium such as a CD-ROM, flash memory, or flexible disk, or from an external storage medium via a network.

In the embodiments of the present invention, the device management 80 shown in FIG. 14 has been exemplified as an application. However, the present invention is not limited to such specific example. The present invention is feasible and effective in arbitrary applications having similar functions.

In the embodiments of the present invention, the TWAIN application 142 shown in FIGS. 6B and 14 has been exemplified as an application. However, the present invention is not limited to such specific example. The present invention is feasible and effective in arbitrary applications having similar functions such as an application required to print an image and document.

In the embodiments of the present invention, the personal computer has been assumed as the information processing apparatus. However, the present invention is not limited to such specific example. The present invention is feasible and effective for arbitrary information processing apparatuses (terminals) which allow similar use methods such as a DVD player, game, set-top box, and Internet home appliances.

In the embodiments of the present invention, the MFP has been exemplified as a peripheral device. In addition, the present invention is also applicable to any of peripheral devices such as a copying machine, facsimile, scanner, digital camera, digital video camera, and multifunction peripheral including these functions.

In the embodiments of the present invention, the OS equivalent to Windows 7 is used as an example of the OS. However, the present invention is not limited to such specific OS, and arbitrary OSs may be used.

In the embodiments of the present invention, Ethernet is used as the configuration example of the network 4. However, the present invention is not limited to such specific example, and other arbitrary network configurations may be adopted.

In the embodiments of the present invention, Ethernet is used as the interface between the PC 1 and the MFPs 3, 777, 888, and 7. However, the present invention is not limited to such specific interface. For example, arbitrary interfaces such as a wireless LAN, IEEE1394, Bluetooth, and USB may be used.

In the embodiments of the present invention, the WSD has been exemplified as a Web service protocol, and the case has been exemplified wherein the TWAIN application 142 is launched by designating a WIA driver name as the first argument on the device management screen 600, and controls the MFPs 3, 777, and 888 via the TWAIN driver 141 using the WSD protocol. However, the present invention is not limited to such specific example. For example, the TWAIN application 142 may be launched by designating a WIA driver name as the first argument on the device management screen 600 using an arbitrary protocol such as an IHV unique protocol, and may control the MFPs via the TWAIN driver 141 using that protocol.

In the embodiments of the present invention, the case has been exemplified wherein when the user presses the image scan (TWAIN) button 611 on the device management screen 600, the TWAIN application 142 is launched while setting an appropriate device (driver). However, the present invention is not limited to such specific example. For example, the present invention is applicable to various functions, so that an appropriate device (driver) name is designated when an arbitrary application is launched from the device management screen, when a Web site is to be linked, or when a service is provided.

In the OS such as Windows 7, when a plurality of devices, which are the same model but are different individuals, are connected to the single PC via the USB interface 14, the same TWAIN driver name has to be used. This is because the OS cannot generate TWAIN DS, that is, TWAIN driver names, which are required to identify TWAIN devices of the same model connected to the USB interface 14, and to specify individual devices. However, by adding, to a future OS, a function which allows to generate TWAIN driver names required to identify TWAIN devices of the same model connected to the USB interface 14 and to specify individual devices using, for example, serial numbers, the present invention can be applied to a local-connection interface such as the USB interface 14.

In the embodiments of the present invention, the following example has been described. That is, the TWAIN application 142 is configured to save a device which was used at the previous launch timing as a default device. Then, when the user presses the image scan (TWAIN) button 611 on the device management screen 600, the TWAIN application 142 is launched while setting an appropriate device (driver) associated with the device management screen 600 in place of the default device saved at the previous launch timing. Furthermore, when an appropriate device (driver) is not found, the default device saved at the previous launch timing is referred to, and the TWAIN application 142 is launched while setting that device (driver). As for the default device saving (decision) means, the present invention is not limited to this example. For example, the TWAIN application 142 may include a default device setting screen, and may allow the user to set and change a default device only on the default device setting screen without setting or changing a default device at the launch or quit timing of the TWAIN application 142.

More specifically, the embodiments of the present invention can provide the following effects.

A case will be assumed wherein a plurality of peripheral devices, which have the same model name and different pieces of unique information (for example, serial numbers), are connected on a single network. In this case, when an application (TWAIN application) is launched from a device management screen, one of these plurality of peripheral devices, which was used at the previous launch timing of the application, is associated with the application. Therefore, an appropriate peripheral device (TWAIN driver) can be selected to launch the application (TWAIN application), thus assuring high user's operability.

In another embodiment, the TWAIN application automatically generates a TWAIN driver name dedicated to a peripheral device selected on the device management screen such as Device Stage using a variable that represents a WIA driver name. Hence, the TWAIN application can be launched while an optimal TWAIN driver dedicated to the peripheral device is selected, thus assuring high user's operability.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-150266, filed Jun. 30, 2010 and 2010-159169, filed Jul. 13, 2010, which are hereby incorporated by reference herein in their entirety.

What is claimed is:

1. An information processing apparatus, which executes a peripheral device management program required to manage a peripheral device having unique information, and an application for the peripheral device, said apparatus comprising:
an application launching unit, configured to instruct a function of the peripheral device management program to launch the application;
a management unit, configured to manage peripheral device information including a device name of a peripheral device selected at a quit timing of the application, and unique information of the peripheral device;
a setting unit, configured to set a device name as an argument when said application launching unit launches the application; and
a control unit, configured to control the application to load peripheral device information that includes a device name matching the device name set as the argument and is managed by said management unit when said application launching unit launches the application, and controls to associate a peripheral device corresponding to unique information included in the loaded peripheral device information with the application.

2. The apparatus according to claim 1, wherein the unique information includes a MAC address as unique information of a network.

3. The apparatus according to claim 1, wherein the unique information includes a serial number of a peripheral device.

4. The apparatus according to claim 1, wherein said control unit controls to associate the peripheral device with the application using a driver name which uses the device name and unique information included in the loaded peripheral device information.

5. An information processing apparatus, which executes a peripheral device management program required to manage a peripheral device having unique information, and a plurality of applications for the peripheral device, said apparatus comprising:
an application launching unit, configured to instruct a function of the peripheral device management program to launch a first application and a second application; and
a control unit, configured to acquire a driver name including unique information associated with the second application when said application launching unit launches the first application, and controls to associate a peripheral device corresponding to the unique information included in the acquired driver name with the first application.

6. An information processing apparatus, which executes a peripheral device management program required to manage a peripheral device having unique information, and an application for the peripheral device, said apparatus comprising, as functions of the application:
an acquisition unit as a first application function configured to acquire a device name as an argument when the application is instructed to be launched by a function of the peripheral device management program;
a management unit as the application function configured to manage peripheral device information including a device name of a peripheral device selected at a quit timing of the application and unique information of the peripheral device; and
a control unit as the application function configured to control to load peripheral device information that includes a device name matching the device name acquired as the argument and is managed by said management unit, and to associate a peripheral device corresponding to unique information included in the loaded peripheral device information with the application.

7. A control method of an information processing apparatus, which executes a peripheral device management program required to manage a peripheral device having unique information, and an application for the peripheral device, the method comprising:
an application launching step of instructing a function of the peripheral device management program to launch the application;
a management step of managing peripheral device information including a device name of a peripheral device selected at a quit timing of the application, and unique information of the peripheral device;
a setting step of setting a device name as an argument when the application is launched in the application launching step; and
a control step of controlling to load the managed peripheral device information that includes a device name matching the device name set as the argument when the application is launched in the application launching step, and controlling to associate a peripheral device corresponding to unique information included in the loaded peripheral device information with the application.

8. A control method of an information processing apparatus, which executes a peripheral device management program required to manage a peripheral device having unique information, and a plurality of applications for the peripheral device, and comprises a storage unit of a selected driver selected by the application program, the method comprising:
an application launching step of instructing a function of the peripheral device management program to launch a first application and a second application; and
a control step of acquiring a driver name including unique information associated with the second application when the first application is launched in the application launching step, and controlling to associate a peripheral device corresponding to the unique information included in the acquired driver name with the first application.

9. A control method of an information processing apparatus, which executes a peripheral device management program required to manage a peripheral device having unique information, and an application for the peripheral device, the method comprising, as functions of the application:
an acquisition step as the application function of acquiring a device name as an argument when the application is instructed to be launched by a function of the peripheral device management program;
a management step as the application function of managing peripheral device information including a device name of a peripheral device selected at a quit timing of the application and unique information of the peripheral device; and
a control step as the application function of controlling to load the managed peripheral device information that includes a device name matching the device name acquired as the argument, and to associate a peripheral device corresponding to unique information included in the loaded peripheral device information with the application.

10. A program for controlling a computer to function as units included in an information processing apparatus according to claim 1.
